(19) United States
(12) Patent Application Publication
(10) Pub. No.: US 2008/0187739 A1
(43) Pub. Date: Aug. 7, 2008

(54) Compositions for use as building materials, other molded items, and methods of and systems for making them

(76) Inventors: Charles H. Baker, Overland Park, KS (US); Jeffrey Jacob Cernohous, Hudson, WI (US); Virgil Smail, Manhattan, KS (US)

Correspondence Address: Eileen M. Ebel;Bryan Cave LLP, 1290 Avenue of the Americas, New York, NY, 10104, US

(21) Appl. No.: 12/009,093

(22) Filed: Jan. 16, 2008

Related U.S. Application Data
(60) Provisional application No. 60/880,667, filed on Jan. 16, 2007.

(51) Int. Cl. B32B 5/16; B29C 47/06; B29D 31/00; B65D 19/32

(52) U.S. Cl. 428/297.7; 156/500; 156/242; 206/386

(57) ABSTRACT

A high strength, light weight composite has: (a) a core comprising a thermoset polymer and having a surface and (b) a laminate bonded to at least a portion of the surface of the core, the laminate comprising: (i) at least one layer of fibrous material having a surface, and (ii) at least one layer of thermoset binder which is bonded to at least a portion of the surface of at least one layer of fibrous material, each thermoset binder layer optionally comprising a low density filler. Also provided are methods for making and systems and apparatus for manufacturing the composite.

### RELATED APPLICATIONS

The present application claims the benefit of U.S. Provisional Application No. 60/880,667, which was filed on Jan. 16, 2007 and which is incorporated herein in its entirety for all purposes.

### BACKGROUND OF THE INVENTION

In the United States, sales of wood products exceed $200 billion annually. Building products are perhaps the most important segment of this market, and their sales may exceed $100 billion annually. Wood is easily fabricated, is relatively low cost, and has a remarkable strength-to-weight ratio. Wood products are used in many types of building materials, e.g., decking, siding, framing, roofing, and fencing. Wood has several drawbacks, however. It degrades rapidly in the presence of moisture and has anisotropic mechanical properties, poor UV resistance, and poor dimensional stability. Wood products must be periodically treated or coated to protect them in most applications. Even with regular maintenance, it is often necessary to replace wood products after a relatively short period of time as compared to the lifetime of a building or other construction project.

Polymer wood composite (“PWC”) materials have recently begun to replace wood in non-structural applications, such as decking. These composite materials are conventionally made by profile extruding a blend of wood-filled polyolefins and/or polyvinylchloride. PWC materials have gained rapid acceptance in the marketplace because they are almost maintenance-free and are more resistant to the environment than conventional wood products. Despite the fact that these products have been sold for only 10-15 years, they constitute a market worth several billion dollars annually with double-digit annual growth.

However, PWC materials sell at a 2- to 3-fold premium over wood products. This premium can be expected to increase as oil prices continue to rise. PWC materials also have significantly lower strength-to-weight ratios compared to those of wood products. In some cases, PWC materials have strength-to-weight ratios less than one-tenth of those of comparable wood products. Accordingly, use of PWC materials has been limited to non-structural applications.

Wood is used as a filler in such composites because it is low cost (about $0.10/pound), readily available, and yields an end product resembling in appearance the wood material it replaces. However, the use of wood as a filler in composite materials has significant drawbacks. PWC materials easily fade, suffer tannin staining, are heavy, i.e., have a density about 1.1 grams per cubic centimeter (2 to 3 times the density of pine, a typical building material), and are difficult to manufacture. Variable characteristics of the starting materials such as moisture content cause inconsistent dimensions in the resulting product unless adaptations are made to the process to account for these variations.

Alternatives to wood fillers have been considered, but none have demonstrated a significant cost-benefit advantage. For example, use of a mineral filler, such as talc or mica, produces a composite product that is much heavier and more brittle than a PWC product. Light-weight, non-wood materials have also been considered. They usually consist of a void that is surrounded by a thin layer of material, resulting in a low-density structure. Use of these low-density structures in conventional products using conventional processes renders them susceptible to crushing, which impedes the use of such structures as light-weight or low density fillers.

Most current PWC composites have a polyolefin polymer matrix, and extrusion processes are utilized to melt the polymer and encapsulate the filler. However, extrusion processes are characterized by high temperature and pressure, and if used with light-weight, non-wood fillers, those processes crush the fillers and produce composite materials that are much heavier than PWC products. Also, the extrusion equipment must be designed to produce and withstand those high pressures and temperatures, which adds cost. Furthermore, extrusion products must be cooled at the end of production before further processing or handling, which increases production cost.

It would be advantageous to have composites that come closer to the strength-to-weight ratio and other mechanical properties of wood, have densities lower than wood, and are low cost. It would also be advantageous to have methods of making such composites where the methods do not have the drawbacks of extrusion processes.

### SUMMARY OF THE INVENTION

The present invention provides a composite having a good strength to weight ratio and a long life span of usefulness. As compared to PWC, the composite of the present invention can be about half the density and twice the strength. It is also anticipated that the composite may remain useful as a building material or molded item of manufacture for perhaps 20 years or longer.

The present invention provides a composite comprising:

(a) a core comprising a thermoset polymer and having a surface; and

(b) a laminate bonded to at least a portion of the surface of the core, the laminate comprising:
(i) at least one layer of fibrous material having a surface, and
(ii) at least one layer of thermoset binder which is bonded to at least a portion of the surface of at least one layer of fibrous material, and wherein each thermoset binder layer optionally comprises a low density filler.

In a preferred embodiment of the present invention, at least one of the at least one thermoset binder layers comprises the low density filler.

The composite may have more than one layer of fibrous material. With a composite having two major faces and two or more layers of fibrous material, all or only some of the fibrous material layers may be on one of the faces and the rest of the layers on the other face.

The present invention also provides a method of making a composite comprising:

(a) providing a mold having an interior surface;

(b) providing a first layer of fibrous material adjacent at least a portion of the interior surface of the mold, the layer having a first major face and a second major face, the first major face being towards that portion of the interior surface of the mold and the second major face being away from that portion of the interior surface of the mold;

(c) providing a first thermoset binder layer adjacent the first layer of fibrous material, the thermoset binder layer comprising thermoset binder and optionally a low density filler;

(d) providing a thermoset polymer adjacent the first thermoset binder layer;

(e) causing at least some of the thermoset binder of the first thermoset binder layer to flow into the first layer of fibrous material;

(f) curing the thermoset polymer to form a core; and

(g) curing the thermoset binder to form a laminate, the laminate comprising the layer of fibrous material and the thermoset binder; and

wherein the laminate is bonded to at least a portion of the core.

In a preferred embodiment, the first thermoset binder layer comprises the low density filler. In step (d), the thermoset polymer may be placed proximate (directly adjacent) the first thermoset binder layer or the first layer of fibrous material.

The present invention also provides embodiments for use of the composite in various building materials or other molded objects. The present invention provides, for example, a pallet sheet and a pallet for carrying one or more objects, a deck board, a high strength building component, a siding or roofing panel, and a unit of furniture for use as a table or seating, each of which incorporates one or more composites of the present invention.

In another aspect of the present invention, a system is provided for manufacturing a composite comprising:

a first spindle to hold a fibrous material to provide a first fibrous material layer;

a first frame that defines a path upon which the first fibrous material layer travels toward a double belt press;

a first dispenser for dispensing a thermoset binder optionally comprising a low density filler onto the fibrous material to provide a first thermoset binder layer adjacent the first fibrous material layer;

optionally, but preferably, a first scoring apparatus that is disposed in the path of the first fibrous material layer and that scores the first fibrous material layer as it travels by the first scoring apparatus;

optionally, but preferably, a first shaper that shapes the first fibrous material where it was scored by the scoring apparatus;

a double belt press that can engage the first fibrous material layer and adjacent first thermoset binder layer such that the fibrous material can travel from the first spindle toward the double belt press, the double belt press having an upper belt and a lower belt that for at least some distance face each other;

an apparatus for dispensing a thermoset polymer onto the thermoset binder or the first fibrous material layer to provide a thermoset polymer layer, thereby forming an uncured composite;

bands disposed around each belt of the double belt press, wherein two bands are disposed around the upper belt and spaced apart and two bands are disposed around the lower belt and spaced apart such that for at least some of the distance where the belts are facing each other the bands around the upper belt and the bands around the lower belt are in contact and the space bounded by the upper bands, lower bands, upper belt, and lower belt defines a dynamic mold in which the uncured composite is held and can cure as it travels through the double belt press.

In a further aspect of the present invention, a foaming polyurethane is preferably used as the thermoset polymer of the core of the composite. With regard to this embodiment, a method of making a composite using the system of the present invention is provided wherein the thermoset polymer is a foaming polyurethane or a blend comprising a foaming polyurethane and wherein as the polyurethane foams in the mold, the reaction generates heat and pressure that cause thermoset binder to enter the adjacent fibrous material layer and curing of the thermoset binder.

In another aspect of the present invention, a light-weight rigid member is provided which comprises: (a) a construct comprising from about 60% to about 90% by weight of a thermoset polymer and from about 10% to about 40% by weight of low density filler and having a surface; and (b) a skin which is adhered to at least a portion of the surface of the construct; and wherein the member has a density of from about 0.1 to about 40 pounds per cubic foot. In this aspect of the invention, expanded volcanic ash is used in a manner that provides a light-weight rigid member at low cost. Although the rigid member is quite light-weight, it can be used as a building material where strength is not a required feature of its use. It can be used as fascia board, for instance.

### BRIEF DESCRIPTION OF THE DRAWINGS

FIG. 1 shows schematically a composite of the present invention. Various embodiments are shown in FIG. 1A through FIG. 1G.

FIG. 1A shows a composite having a core and a laminate which has one layer of fibrous material and one layer of thermoset material.

FIG. 1B shows a composite having the elements as in FIG. 1A although in an alternative shape which is cylindrical.

FIG. 1C shows a composite as in FIG. 1A in which the laminate includes low density filler.

FIG. 1D shows a composite as in FIG. 1C in which the core also includes low density filler.

FIG. 1E shows a composite as in FIG. 1A except in which the laminate has two layers of fibrous material and of thermoset binder.

FIG. 1F shows a composite as in FIG. 1A which has a second laminate disposed on the opposite side of the core from the first laminate.

FIG. 1G shows an end view of a composite as in FIG. 1F with a skin thereon.

FIG. 2 depicts various aspects of providing component composite materials to a mold for curing. Two embodiments are shown in FIG. 2A and FIG. 2B.

FIG. 2A depicts composite components in an open mold 100 (before the mold is covered) for molding a composite.

FIG. 2B depicts composite components in an open mold 100 (before the mold is covered) for molding a composite having two laminates.

FIG. 3 is a simplified block diagram of a composite manufacturing line.

FIG. 4 depicts a portion of the system of the present invention which involves providing and arranging composite component materials in-line to prior to entry into the double belt press mold.

FIG. 4A provides a broad view schematic of a system in which composite component materials may be provided and arranged in-line for entry into and curing in a double belt press mold.

FIG. 4B provides a close view of a system in which composite component material may be provided and arranged in-line showing the area before entry into the double belt press mold. It also shows an embodiment is which component composite materials are provided for molding a composite having two laminates.

FIG. 5 is an end view of the apparatus of FIGS. 4A and 4B looking from left to right in those figures. This shows the point at which the two belts of the double belt press have come close enough so that the two upper bands (on the upper belt) and the two lower bands (on the lower belt) meet and with the portions of the two belts between the bands form a dynamic or traveling mold in which the composite of this invention is preferably cured.

FIG. 6 shows a siding panel made in accordance with this invention and having indentations to facilitate placement and interlocking of one such panel with another such panel.

These drawings are provided for illustrative purposes and should not be used to unduly limit the scope of the invention.

### DETAILED DESCRIPTION OF THE INVENTION

As used herein, the term “adjacent” with reference to the position or placement of a layer or item next to another referred layer or item, means that the referred layer or item is either contiguously next to the layer or item or another one or more layers or items are contiguously disposed therebetween. “Proximate” as used herein means the referred layers or items are directly adjacent, i.e., contiguous or contacting each other.

Where it is stated that an item is “connected to” some other item, it is meant, unless otherwise indicated, that the item as a separate piece has been fastened, adhered or otherwise attached to the other item. It also encompasses situations where the item and the other item have been integrally molded together, e.g., by a curing process.

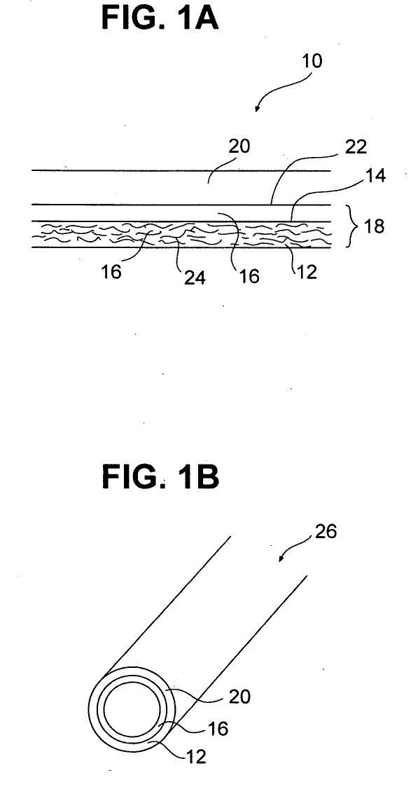

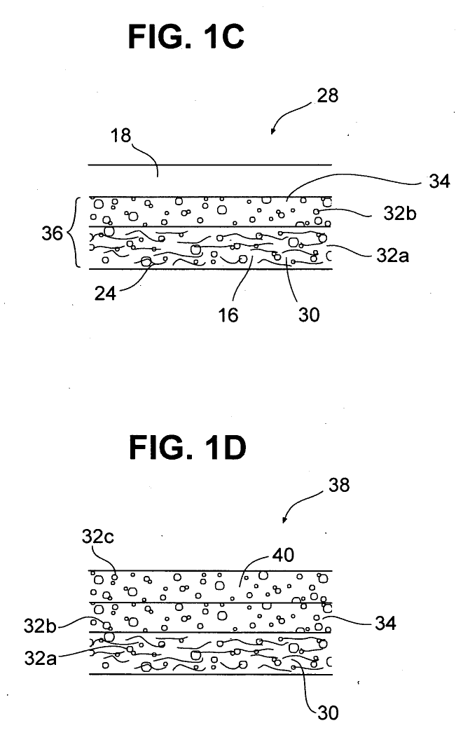

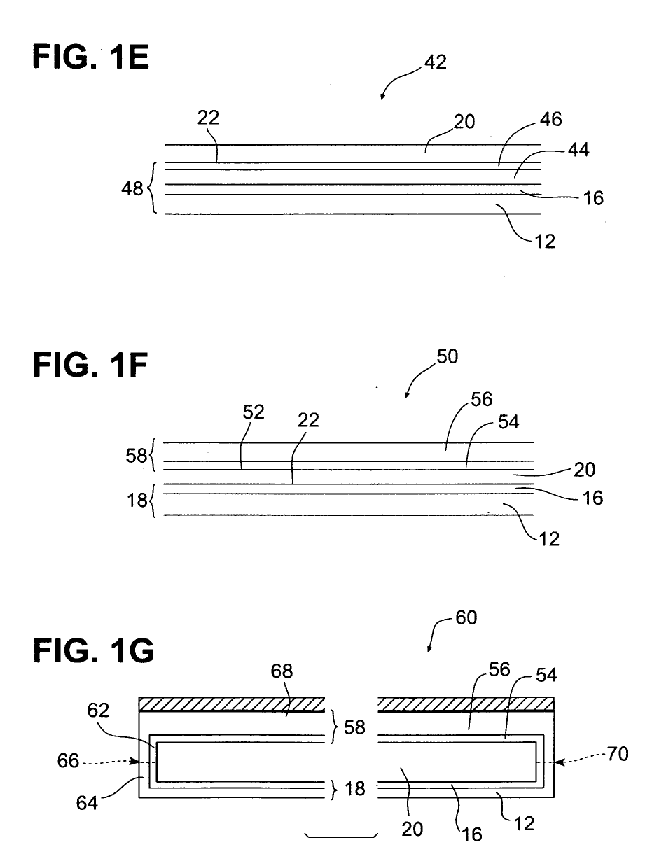

With reference to the accompanying FIG. 1, a composite of the present invention is shown in various embodiments. The composite is a light-weight, high strength material that is useful as a building material or as a molded item of manufacture. FIG. 1A shows a composite 10 having a fibrous material layer 12 which has a surface 14. A layer of thermoset binder 16 is bonded to at least a portion of the surface 14 of fibrous material layer 12. At least one fibrous material layer 12 and at least one thermoset binder layer 16 bonded together comprise laminate 18. (It is noted that fibrous material layer 12 and thermoset binder layer 16 are also referred to as first fibrous material layer 12 and first thermoset binder layer 16 in certain subsequent embodiments.) Laminate 18 imparts strength and structural integrity to composite 10. Composite 10 also has a core 20, which comprises a thermoset polymer and has a surface 22. Laminate 18 is bonded to at least a portion of surface 22 of core 20. In composite 10, thermoset binder layer 16 of laminate 18 is bonded to at least a portion of surface 22 of core 20.

Fibrous material layer 12 is a layer of fibrous material that comprises fibers 24. Fibers 24 can be of the same or different length and of the same or different diameter and are laid down in organized or random manner. The fibrous material of fibrous material layer 12 can be a woven or non-woven material. Examples of a fibrous material include glass fibers, carbon fibers, cellulosic materials, and aromatic polyamide fibers. The fibrous material typically comprises a fiber having a tear strength of from about 1 to 25 pounds. As would be understood, the stronger the fibrous material layer 12 used, the stronger and more durable the resulting composite.

Fiberglass mat may be used as the fibrous material and can be obtained from any commercial supplier, such as GAF or Owens Corning. The aromatic polyamide fibers that can be used include Kevlar™ fibers.

In an embodiment of the present invention, the composite has a fibrous material having a tear strength of from about 6 to 8 pounds.

In composite 10, a portion of fibrous material layer 12 is shown in cross section to depict fibers 24 and illustrate that fibrous material layer 12 is porous (it has interstices between fibers 24). Fibrous material layer 12 has thermoset binder 16′ within at least a portion of the pores. Thermoset binder 16′ within the pores of the fibrous material is the same as the thermoset binder present in the adjacent thermoset binder layer 16. Laminate 18 comprising fibrous material layer 12 having thermoset binder 16′ within the pores thereof and thermoset binder layer 16 provides structural integrity to composite 10.

A wide variety of polymeric substances are recognized in the art as thermosetting resins. Thermoset resins are resins that when cured produce a crosslinked or network polymeric matrix. Thermoset resins are suitable for use as the thermoset binder of thermoset binder layer 16 (which is also thermoset binder 16′ in the pores of fibrous material layer 12) and as the thermoset polymer of core 20. The terms “thermoset resin,” “thermoset binder” and “thermoset polymer” refer herein to either their cured or uncured form depending on usage. Examples of thermoset resins of the present invention include, but are not limited to, epoxies, polyurethanes, phenol-resorcinol polymers, urea-formaldehyde polymers, polyureas, phenol-formaldehyde polymers, melamine-formaldehyde polymers, soy-based polymers, polyesters, polyimides, acrylics, cyanoacrylates, polyanhydrides, polydicyclopentadienes, polycarbonates, blends of any of the foregoing, and blends of any of the foregoing with at least one linseed oil-based polymer. Suitable thermoset resins are commercially available. The thermoset binder and the thermoset polymer are each independently selected from recognized thermoset resins including the examples listed. In a given composite, the thermoset binder and the thermoset polymer can be the same or a different thermoset resin or blend of thermoset resins. If more than one fibrous layer is present in a laminate, the thermoset binder associated with each fibrous layer can be the same as or different from the thermoset binder associated with any of the other fibrous layers.

In one embodiment, the thermoset binder is epoxy or a blend of thermoset binders comprising epoxy.

In one embodiment, the thermoset polymer is polyurethane or a blend of thermoset polymers comprising polyurethane. The polyurethane is preferably a foaming polyurethane.

In a preferable aspect of the present invention, a method is provided in which pressure and heat from the exothermic reaction of the curing (e.g., a foaming polyurethane reaction) forces the thermoset binder into the fibrous material layer for additional structural integrity and the heat generated causes the cure of the thermoset binder. No externally supplied heat is required and the pressure is generated from the expansion of, e.g., the polyurethane as it foams in a fixed volume within the mold.

In a preferred embodiment of composite 10, the thermoset binder is epoxy or a blend of thermoset binders comprising epoxy and the thermoset polymer is polyurethane or a blend of thermoset polymers comprising polyurethane. Preferably, the polyurethane is a foaming polyurethane. In a more preferred embodiment, the thermoset binder is epoxy and the thermoset polymer is polyurethane, more preferably a foaming polyurethane.

Examples of useful commercially available thermoset resins are indicated as follows. VFI 742 from Volatile Free of Milwaukee, Wis. is a polyurethane rigid molding foam system. A modified version of this product is also available which has 10% sucrose included for improved bonding and rigidity. These polyurethane systems are preferable for use as the thermoset polymer of core 20. Polyurethane is also available from other sources such as Dow or Bayer.

Other examples of useful commercially available products include the following. D.E.R.™ 383 from Dow and EPON™ Resin 8132 from Hexion Specialty Chemicals are liquid epoxy resins. These epoxy resins are advantageously used as the thermoset binder.

Epoxy curing agents may be used to assist in curing epoxy resin by reacting with the epoxide groups or by promoting self-polymerization of the epoxy by catalytic action. Curing agents are well known to those of skill in the art and many are commercially available. D.E.H.™ 29 from Dow is a liquid aliphatic polyamine curing agent and EPIKURE™ Curing Agent 3010 from Hexion is an amidoamine curing agent. Both are useful curing agents for epoxy resins in accordance with the present invention.

A thermosetting urea-formaldehyde (UF) or phenol-formaldehyde (PF) resin may be used as the thermoset resin and can be prepared from urea, phenol and formaldehyde, monomers or from UF or PF precondensates in a manner well known to those skilled in the art. UF and PF reactants are commercially available in many forms. Any form which can react with the other reactants and which does not introduce extraneous moieties deleterious to the desired reaction and reaction product can be used in the preparation of UF or PF resins useful in the invention.

Formaldehyde for making suitable UF or PF resins is available in many forms. Paraform (solid, polymerized formaldehyde) and formalin solutions (aqueous solutions of formaldehyde, sometimes with a small amount of methanol, in 37 percent, 44 percent, or 50 percent formaldehyde concentrations) are commonly used forms. Formaldehyde also is available as a gas. Any of these forms is suitable for use in preparing a UF resin in the practice of the invention. Typically, formalin solutions are preferred as the formaldehyde source for ease of handling and use.

Similarly, urea is available in many forms. Solid urea, such as prill, and urea solutions, typically aqueous solutions, are commonly available. Further, urea may be combined with another moiety, most typically formaldehyde and urea-formaldehyde adducts, often in aqueous solution. Any form of urea or urea in combination with formaldehyde is suitable for use in the practice of the invention. Both urea prill and combined urea-formaldehyde products are preferred, such as Urea-Formaldehyde Concentrate or UFC 85. These types of products are disclosed in, for example, U.S. Pat. Nos. 5,362,842 and 5,389,716 (which patents are hereby incorporated herein in their entireties for all purposes) and are well known to those skilled in the art.

Any of a wide variety of procedures used for reacting the urea and formaldehyde components to form an aqueous UF thermosetting resin composition can be used, such as staged monomer addition, staged catalyst addition, pH control, amine modification and the like. The present invention is not limited to a restricted class of UF resins or any specific synthesis procedure. Generally, urea and formaldehyde are reacted at a mole ratio of formaldehyde to urea in the range of about 1.1:1 to 4:1, and more often at an F:U mole ratio of between about 1.5:1 to 3.2:1.

Many thermosetting formaldehyde based resins which may be used in the practice of this invention are commercially available. Urea-formaldehyde resins such as the types sold by Georgia Pacific Resins, Inc., including 544D49, 544D97 and 670D17 for wood bonding applications, and those sold by Hexion Chemical Co. and by Dynea may be used. These resins are prepared in accordance with art-recognized teachings. They contain reactive methylol groups which upon curing form methylene or ether linkages. Such methylol-containing adducts may include N,N′-dimethylol-dihydroxymethylolethylene; N,N′bis(methoxymethyl)-N,N′dimethylolpropylene; 5,5-dimethyl-N,N′-dimethylolethylene; N,N′-dimethylolethylene, and the like.

Urea-formaldehyde resins useful in the practice of the invention generally contain 45 to 75%, and preferably, 55 to 65% non-volatiles, generally have a viscosity of 50 to 1400 cps, preferably 150 to 600 cps, normally have a pH of 7.0 to 9.0, preferably 7.5 to 8.5, and often have a free formaldehyde level of not more than about 3.0%, often less that 1%, and a water dilutability of from less than 1:1 to 100:1, preferably 1:1 and above.

The reactants for making thermoset resins such as UF or PF resins may also include a small amount of resin modifiers such as ammonia, alkanolamines, or polyamines, such as an alkyl primary diamine, e.g., ethylenediamine (EDA). Additional modifiers such as melamine, ethylene ureas, and primary, secondary and tertiary amines, for example, dicyanodiamide, can also be incorporated into UF resins used in the invention. Concentrations of these modifiers in the reaction mixture often will vary from 0.05 to 20.0% by weight of the UF resin solids. These types of modifiers promote resistance to hydrolysis, polymer flexibility and lower formaldehyde emissions in the cured resin. Urea may have additional use in scavenging formaldehyde or as a diluent.

Another component that may be used with a thermoset resin in the present invention is a protein and any suitable protein may be added to a thermoset resin or thermoset resin blend. The use of a protein is preferable in a UF or PF resin, although it can be used with any thermoset resin. A preferable protein is soy protein. The addition of an effective, binding-enhancing amount of a modified soy protein to any thermosetting UF resin of the present invention, for example, yields lightweight composites having improved internal bond strength as compared with composites made with UF or PF resins without the addition of a protein.

Modified soy protein is prepared by reaction of soy protein with either of two classes of modifiers. The first class of modifiers includes saturated and unsaturated alkali metal C₈-C₂₂ sulfate and sulfonate salts. Two preferred modifiers in this class are sodium dodecyl sulfate and sodium dodecylbenzene sulfonate. The second class of modifiers includes compounds having the formula R₂NC(═X)NR₂, wherein each R is individually selected from the group consisting of H and C₁-C₄ saturated and unsaturated groups, and X is selected from the group consisting of O, NH, and S. The C₁-C₄ saturated groups refer to alkyl groups (both straight and branched chain) and the unsaturated groups refer to alkenyl and alkynyl groups (both straight and branched chain). The preferred modifiers in this class are urea and guanidine hydrochloride. Modified soy protein used in the invention and a method for making the modified soy protein are described in U.S. Pat. No. 6,497,760, the entirety of which is hereby incorporated by reference for all purposes.

The modified soy protein is a powder. Typically, 90 percent of the particles pass through a 50 mesh screen. However, finer powders, such as powders wherein 90 percent of the particles pass through a finer screen such as a 100 mesh, 150 mesh, or 200 mesh screens, also are suitable for use in the thermoset resin of the invention. Typically, modified soy protein can be suspended in water to form a suspension having as much as about 30 wt % solids.

For a UF resin, for example, a suitable thermoset resin material can be prepared by including an amount of protein, e.g., modified soy protein, to provide, on a solids basis, a weight ratio of UF resin solids to protein solids (UF:Protein) between about 99:1 and about 50:50, usually between about 98:2 and about 60:40, preferably between about 95:5 and about 60:40, and most often in the range of about 75:25 to about 65:35. Increasing the proportion of modified soy protein solids requires a longer time to cure the thermoset resin material.

Soy-based resin can alternatively be used as the only thermoset resin. The strength would not be as great as that of other thermoset resins contemplated or as that of a blend of soy with any one or more conventional thermoset resins, although it may be suitable alone in some applications. Soy-based resin as the only thermoset resin could be used as the thermoset polymer in the core, for instance. A stronger thermoset resin such as epoxy or blend of thermoset resins would preferably be used for the laminate of a composite having soy-based resin as the sole thermoset polymer in the core.

Different proportions of modified soy protein can be used to provide desired characteristics and properties. Soy protein can be obtained, for example, from Cargil.

The total concentration of non-volatile components in a thermoset resin composition that includes protein solids also can vary widely in accordance with the practice of the present invention, but it will usually be found convenient and satisfactory to make up this composition at a total solids concentration in the range from about 25 to about 75 percent by weight of the total aqueous thermoset resin composition, usually in the range of about 35 to about 70 percent by weight. Total solids from about 40 to about 65 percent by weight are preferred. As used herein, the solids content of a composition is measured by the weight loss upon heating a small, e.g., 1-5 gram sample of the composition at about 105° C. for about 3 hours.

Another environmentally friendly option involves the use of linseed oil. Linseed oil may be used in low percentage in a blend with one or more other thermoset resins of the present invention. Linseed oil may be used with a conventional thermoset resin, for instance, in a blend where the soy resin is present from about 5 wt. % to 20 wt. % of the total thermoset resin blend.

By adding an acid catalyst to a UF resin, the rate of cure of the thermoset resin can also be adjusted to a desired speed. UF resin-based thermosets may even be cured at ambient temperatures by catalysis with free acid. Oftentimes, a combination of a moderate increase in acidity and an elevated temperature is employed to cure the thermoset resin in a conventional molding process.

Skilled practitioners recognize that composite 10 can be manufactured with multiple thermoset resin systems, and are familiar with methods for manufacturing such products. Skilled practitioners recognize that different thermoset resins can be used to provide characteristics and properties as desired for use as the thermoset polymer and/or as the thermoset binder.

At the interface of the thermoset polymer at surface 22 and the thermoset binder of thermoset binder layer 16 a bond is formed between laminate 18 and core 20. In an embodiment of the present invention, composite 10 has a bond between the thermoset binder layer and the core which results from the thermoset binder or the thermoset polymer of the core curing while in contact with the other. When one of the materials was previously cured and the other then applied and cured, the bond is strong although it is noticeable in that a line at the joint is visible.

In another embodiment, composite 10 has a bond between the thermoset binder and the thermoset polymer which results from each curing while in contact with the other. When both are cured together a thin mix layer is present although it is less visible at the joint than when the bond is formed from one being cured with a previously cured resin. The bond formed from both curing together is the stronger bond. Strength of the bond is also governed by the strength of the particular thermoset resin(s) used.

In a preferred embodiment in which thermoset polymer is polyurethane and thermoset binder is epoxy, the bond is advantageously made between two compatible aromatic compounds. Also, epoxy has a number of hydroxyl and amine groups available to which polyurethane can bind. As noted above, a strong and less noticeable mix line at the joint results when both compounds are allowed to cure together. Because of the compatibility of the compounds, though, much of the same effect occurs when one is already cured and the other is uncured when first brought in contact with the first one and then cured while still in contact with it.

The composite of the present invention can be a variety of shapes. The composite can typically be a rectangular shape as shown in FIG. 1A. Other shapes are also contemplated. The composite 26 as shown in FIG. 1B is cylindrical. In another embodiment, for example, the composite can comprise a portion that is substantially in the shape of a polyhedron, e.g., a prism. A variety of composite shapes can be used as construction elements. Shapes of conventionally molded items are also possible.

In accordance with the present invention, each thermoset binder layer optionally comprises a low density filler. In FIGS. 1A and 1B, thermoset binder layer 16 is shown without low density filler. In a preferred embodiment of the present invention, at least one of the at least one thermoset binder layers comprises low density filler. The presence of a low density filler provides additional strength to the layer.

FIG. 1C depicts composite 28 in which laminate 36 includes low density filler. Thermoset binder layer 34 includes low density filler 32b in addition to thermoset binder. Fibrous material layer 30 also has low density filler, here designated low density filler 32a. Fibrous material layer 30 also includes fibers 24 and thermoset binder 16′. The low density filler 32a in fibrous material layer 30 is the same low density filler or blend of low density fillers as is designated low density filler 32b of thermoset binder layer 34.

Advantageously, a “filler” in accordance with the present invention does not demonstrate viscoelastic characteristics under the conditions provided by the methods and systems of the present invention. “Low density filler” of the present invention is a light-weight, inert filler material with a density of from about 0.01 to about 0.5 grams per cubic centimeter. Examples of low density filler are expanded volcanic ash, pumice, perlite, pumiscite, mineral fillers, glass microspheres, soybean hulls, rice hulls, polymeric microspheres, cenospheres, and vermiculite.

In an embodiment of the present invention, low density filler is chosen which has a density of from about 0.01 to about 0.4 grams per cubic centimeter. In a further embodiment, low density filler is chosen which has a density of from about 0.01 to about 0.3 grams per cubic centimeter.

Mineral fillers include, for example, talc, silica and alumina. Low cost glass microspheres are made from fly ash by the burning of coal.

Many of the low density fillers are naturally occurring lightweight inorganic materials. Preferred embodiments are those that incorporate expanded volcanic ash, pumice, perlite, pumicsite, vermiculite and combinations thereof. A most preferred inorganic low density filler is expanded volcanic ash or combinations including expanded volcanic ash. It is understood that the term “expanded volcanic ash” encompasses perlite. Volcanic ash is ash that occurs as fine particles that result from explosive volcanic activity. It consists of very fine rock and mineral particles. Perlite is a generic term for a naturally occurring siliceous rock that is an amorphous volcanic glass. It has a high water content and it greatly expands upon heating. The expanded volcanic ash utilized in the present invention has a density from about 0.01 to about 0.5 grams per cubic centimeter, more preferably from about 0.01 to about 0.4 grams per cubic centimeter and most preferably from about 0.01 to about 0.3 grams per cubic centimeter.

Naturally occurring inorganic low density fillers are typically made using an expansion process. In this process, the filler is exposed to thermal energy such that the material is above its melting point. During this process, the bound moisture in the inorganic lattice (often in the form of a hydrate) rapidly offgases and causes the molten material to undergo a rapid expansion. The resultant inorganic material is very lightweight. Perlite, for instance, softens at temperatures of about 850° C. to about 900° C. When quickly heated, the trapped water vaporizes and the crude rock pops, creating tiny bubbles and causing expansion of the material to about 7 to about 16 times its original volume. As a result of the uncontrolled nature of this process, however, the resultant naturally occurring inorganic low density filler can have a mixture of open and closed cell microscopic morphology. In fact, in commercially available expanded volcanic ash including perlite, as much as 60 wt % of the material possesses an open cell morphology.

Open celled morphologies can be problematic for producing lightweight thermoset composites of this invention as the thermoset resin can flow into the open celled structure during the mixing process thus increasing the overall composite density. This problem also limits the overall amount of naturally occurring lightweight inorganic filler that can be processed with a thermoset resin. As the resin flows into the free volume of the open cells, it makes mixing more difficult at higher low density filler loading levels. For this reason, the naturally occurring inorganic low density fillers of the present invention preferably have a high level of closed cell morphology microstructure. In a preferred embodiment of the present invention, the naturally occurring low density filler preferably has greater than 70 wt % closed cell morphology, more preferably greater than 80 wt %, and most preferably greater than 90 wt %. The level of closed cell microstructure present in a naturally occurring inorganic low density filler can be characterized by dispersing a known mass of the material in water, allowing it to stand for 24 hours and subsequently determining the mass balance of material that remains buoyant and of the material that sinks.

Preferred embodiments of this invention utilize expanded volcanic ash as the low density filler. In a preferred embodiment, the naturally occurring inorganic low density filler such as expanded volcanic ash comprises 5-80 wt % of the composite, more preferably 10-60 wt % of the composite, and most preferably 30-60 wt % of the composite.

Expanded volcanic ash may be surface treated, such as with a lubricant, prior to its inclusion in a thermoset resin mixture of the invention.

Expanded volcanic ash is commercially available. It can be obtained from Kansas Minerals of Mankato, Kansas. Other sources may be used.

Low density filler of the present invention is comprised of particles which measure from about 10 to about 500 microns in at least one dimension. In an embodiment of the present invention, low density filler is chosen such that it has an average particle size that is preferably less than 200 microns in at least one dimension, more preferably less than 150 microns, more preferably less than 100 microns and most preferably less than 50 microns in at least one dimension, as determined using standard light scattering or electron microscopy techniques. Preferred embodiments of the low density filler are highly buoyant naturally occurring lightweight fillers.

The preferred particle size of expanded volcanic ash is from about 10 to about 150 microns in at least one dimension.

Particle shape depends on the substance used as the low density filler. Volcanic ash particles when expanded have various shapes. Some can be spheres and some can be oblong or irregular shaped. Manufactured glass spheres, on the other hand, are typically in the shape of near perfect spheres.

Variation in size and inclusion of smaller sized particles in the low density filler used provides a stronger product. Use of only smaller sized particles can result in fracture of many particles upon introduction of thermoset resin. The resin then fills the fractured spaces, thus preventing some of the desired effect of including low density filler. Use of some larger sized particles reduces this problem by allowing smaller particles to fill the spaces between larger particles. The amount of larger sized particles used should not be too great, however, to avoid undue increase in weight. The variation in particle size used can be achieved by employing one product such as expanded volcanic ash that has a distribution range or by mixing two or more kinds of low density filler to produce a desired profile of particle distribution. Milling volcanic ash prior to expansion and/or sieving through a mesh screen can produce a more uniform distribution. In the case of soybean and rice hulls, however, weight increases upon grinding. Contrary to the considerations mentioned regarding other low density fillers, use of large particles of soybean and rice hulls keeps weight, and thus density, lower.

In an embodiment of the present invention, a mixture of two or more types of low density filler is used. For example, expanded volcanic ash can be used with one or more low density fillers that impart desired characteristics to the composite, e.g., improved impact resistance. Examples of such low density fillers include polymeric microspheres, cenospheres and glass microspheres. Polymeric microspheres useful in this invention include polystyrene microbeads and phenolic microspheres. As indicated above, soybean hulls or rice hulls may be used in a mixture of low density fillers where including particles at the upper size particle range is desired.

In a preferred embodiment, polymeric microspheres, also referred to as “thermoplastic microbeads,” are admixed with a naturally occurring inorganic low density filler to provide an optimum specific gravity and level of impact resistance in the composite. In this instance, this also allows for higher overall low density filler (i.e., the naturally occurring low density filler and the thermoplastic microbeads) loadings. That effectively reduces the resin content of the composite, making the system more economical in the end application. Such composites also have improved durability when compared to wood. This makes them more resistant to scratch and marring in specific end use applications.

FIG. 1D depicts composite 38, which is the same as shown in FIG. 1C except now core 40 comprises low density filler 32c. Including low density filler 32c in core 40 is preferable in that it provides a more rigid structure to the core in addition to contributing to the light-weight advantages of composite 38. Low density filler 32c in core 40 can be the same as or different from low density filler 32a and 32b that is present in fibrous material layer 30 and thermoset binder layer 34, respectively.

In an embodiment of the invention, the core comprises from about 60% to about 90% by weight of a thermoset polymer and from about 10% to about 40% by weight of low density filler where the weight percentages are based on weight of the core. In a preferred aspect of the embodiment, the low density filler is expanded volcanic ash. In another aspect of the embodiment, the core is optionally substantially free from reinforcing fillers that are not also low density fillers to avoid any appreciable weight gain in the core.

In an embodiment of the present invention, the composite has at least one laminate and the at least one laminate comprises at least two layers of fibrous material. FIG. 1E depicts composite 42 having one laminate 48 with two fibrous material layers, a first fibrous material layer 12 and a second fibrous material layer 44. Where there are at least two fibrous material layers in a laminate, as in laminate 48, immediately adjacent layers of fibrous material have between them the thermoset binder layer. Thermoset binder layer 16 is adjacent fibrous material layer 12, as in composite 10 of FIG. 1A. Adjacent thermoset binder layer 16 on the side oppositely disposed from fibrous material layer 12 is second fibrous material layer 44. Adjacent fibrous material layer 44 is second thermoset binder layer 46, which is bonded to surface 22 of core 20. A thermoset binder layer between two layers of fibrous material such as thermoset binder layer 16 in composite 42 can vary in size. Greater strength is generally imparted to a laminate in which the thermoset binder layer is spaced wider between fibrous material layers. It is advantageous to include low density filler (not shown) in the thermoset binder layer between fibrous material layers. The thermoset binder layer between fibrous material layers is typically from about 10 to about 50 thousandths of an inch. Spacing can be increased by use of more low density filler.

In a preferred embodiment, strength can be imparted to the composite by providing two laminates, each bonded to a different surface of the core. FIG. 1F depicts composite 50, which has two laminates, first laminate 18 and second laminate 58. Core 20 has surface 22 and different surface 52. Laminate 18 is bonded to at least a portion of surface 22. Laminate 58 is bonded to at least a portion of different surface 52. Each laminate comprises at least one layer of fibrous material. As shown, laminate 18 comprises first fibrous material layer 12 and first thermoset binder layer 16 and laminate 58 comprises second laminate first thermoset binder layer 54 and second laminate first fibrous material layer 56. In embodiments like composite 50, the laminates are disposed such that they are on opposite sides of the core from each other.

The laminate or laminates provide strength to the composite. Generally, the greater the number of fibrous material layers, the greater the strength provided by the laminate(s) to the composite. Each fibrous material layer can provide approximately 250,000 PSI to the modulus of elasticity (“MOE”). The composite can have more than two fibrous layers, for example, from two to six fibrous layers or even ten or more fibrous material layers. Additional layers of fibrous material are also possible. These fibrous material layers can be within one laminate or divided between or among laminates. More than two laminates are possible for a given composite, particularly where, for example, a composite shape is many-sided. It is noted that as the number of fibrous material layers in a composite increases, the weight also increase. This problem is compounded because as the number of fibrous material layers increases, the additional thermoset binder layers also add weight. To compensate, the weight of the core can be decreased. Use of low density filler in various layers of the composite can offset some of the added weight.

FIG. 1G depicts an end view of composite 60, which has two laminates and a skin. The fibrous material and thermoset binder go around all four sides of the rectangular cross-section of composite 60. A preferable way to produce this configuration is to fold laminates 18 and 58 on the sides at a desired distance such that laminate material from both laminates spans the remaining sides of composite 60. As a result, thermoset binder 62 side layer and fibrous material side layer 64 result from laminates 18 and 58 being folded over to meet each other. Junction lines 66 and 70 indicate where the material of folded laminate 58 meets and the material of folded laminate 18. No junction line is seen in the finished (cured) composite, however, because upon curing, continuous layers surrounding core 20 are formed. Also shown is skin 68, which is a coating that is adhered to the outer surface of at least a portion of composite 60. Skin 68 is here shown proximate to fibrous material layer 56.

The skin can comprise one or more substances to impart desired characteristics to the outer surface of the composite. For example, composites intended for use outdoors may include in the skin substances which will protect from weathering. Composites intended for holding heavy items may include substances having impact resistant properties, etc.

The composite of the present invention may be coated with a thermoset resin to provide additional functionality including antiskid properties, antislip properties, improved scratch and mar resistance, reduced moisture uptake and increased flexural, tensile and impact properties.

Non-limiting examples of substances useful in the skin comprise paint or a thermoset resin selected from the group consisting of polyureas, acrylics, non-rigid, non-foaming polyurethanes, and epoxies, and wherein the thermoset resin for the skin optionally comprises a low density filler or a reinforcing filler. Non-limiting examples of reinforcing fillers include glass fiber, carbon fiber, cellulosic fibers, mineral fibers, talc, mica, glass beads, calcium carbonate or any other filler that imparts the desired mechanical properties to the coating. There may be some overlap between the categories of low density fillers and reinforcing fillers as defined herein.

The composite of this invention can be optionally coated or painted with conventional water or oil based paints and stains to provide color to the composite. Although any paint may be used in the skin, aliphatic paints are preferred. They are UV resistant and no further additions or modifications are required. Many other paints can be used, and many include desirable properties, e.g., exterior oil and water based paints.

Polyurethane coating is typically a non-rigid, non-foaming aromatic polyurethane. Preferably, a commercially available polyurethane is chosen which includes impact resistance and fire retardant properties.

Thermoset resins useful for the skin are commercially available. For example, VFI 207 from Volatile Free Inc. is a polyurea hybrid elasto-plastic polymer. Polyurea P2001/2 from International Polyurethane Systems Inc. is a polyurea elastomer. Polyurea can also be obtained from Huntsman. VFI-2622 and VFI-2623 from Volatile Free Inc. are fast setting, fire retardant polyurethane coatings.

Low density filler or reinforcing filler is preferably included in thermoset resin in the skin, particularly when polyureas or polyurethanes are used. Low density filler or reinforcing filler adds strength and durability to the surface, higher levels of filler add an additional fire retardation effect, and when pigment is added, UV protection is provided. It is understood that there may be some overlap between substances that are low density fillers and that are reinforcing fillers.

Where a UV protectant is added, Tinivuns from Ciba can be used, for example.

In some embodiments paint is used only in the skin. In other embodiments, the various parts of the composite may be admixed with pigments during production to provide color throughout. Preferably, expanded volcanic ash is included in all layers of the composite. When pigment is added to all parts having expanded volcanic ash, the composite product has a more even color. Other ingredients may be included in the skin as well as in any or all of the composite material.

The composite of the present invention may also comprise, within any or all of its component parts, one or more additives. Such additives may include, as non-limiting examples, ultraviolet protectants, compatibilizers, antioxidants, fibers, heat stabilizers, colorants, flame retardants, insecticides, fungicides, plasticizers, tackifiers, processing aids, foaming agents, and impact modifiers. Impact modifiers include polyolefin elastomers, ultra high molecular weight polyethylene (“UHMWPE”), natural and synthetic, rubbers, thermoplastic elastomers and elastomeric polyurethanes. UHMWPE improves impact and crack resistance. Compatibilizers are compounds that allow the filler and thermoset material to bind more tightly, thereby creating a higher strength bond. Compatibilizers encompass substances referred to as coupling agents and antiblocking agents. Processing aids can include lubricants. Tackifiers include sugars such as sucrose. Sucrose may be used, for example, with the thermoset polymer in the core.

The additives may be incorporated into the composite in the form of powders, pellets, granules, or in any other dispersible form. Impact modifiers have particular utility in this invention in some embodiments. Preferred impact modifiers useful in this invention include polyolefin elastomers, ultra high molecular weight polyethylene, natural and synthetic rubbers, thermoplastic elastomers and elastomeric polyurethanes. The amount and type of conventional additives in the composition may vary depending upon the thermoset resin(s) used as well as the desired physical properties of the finished composite. Those skilled in the art of thermoset processing are capable of selecting appropriate amounts and types of additives to complement a specific polymeric matrix in order to achieve desired physical properties in the finished material. Fibers as additives may be, for example, glass fiber, carbon fiber, cellulosic fiber, or mineral fiber. The fiber as additive as used herein is a distinct category from fiber of the fibrous material layer, but there may be some overlap between the types of fibers than can be used as additive fibers and the types of fibers that can be used in the fibrous material layer in the laminate. Care should be taken, particularly where a fiber is not a low density filler, to not add too much fiber in order to avoid excess weight.

The resulting composite of the invention exhibits superior mechanical characteristics in the field of composite materials. The composite of the present invention advantageously has a density, i.e., specific gravity, of from about 0.20 grams per cubic centimeter to about 0.80 grams per cubic centimeter. Preferably, the composite has a density of from about 0.20 grams per cubic centimeter to about 0.70 grams per cubic centimeter. The composite of the invention also has a modulus of elasticity (“MOE”) greater than about 500,000 pounds per square inch. The ASTM test for determining MOE is D5934-02. The composite also has a modulus of rupture of greater than about 2,000 pounds per square inch, and a coefficient of thermal expansion of from about 2.0×10⁻⁷ in/in/° F. to 2.0×10⁻⁵ in/in/° F. Typically, the coefficient of thermal expansion is about 2.0×10⁻⁶ in/in/° F.

In a preferred embodiment, a composite of this invention that comprises expanded volcanic ash, a polyurethane core, and epoxy as the thermoset binder has a specific gravity less than about 0.60 grams per cubic centimeter and a flexural modulus greater than 6000 MPa. In preferred embodiments, the lightweight composite of this invention exhibits tensile and flexural characteristics comparable to natural wood equivalent in weight.

In a preferred embodiment, a composite of the present invention comprises: (a) a core comprising polyurethane and expanded volcanic ash and having a surface and a different surface; and (b) at least one of the following: (i) a laminate bonded to at least a portion of the surface of the core, the laminate comprising at least two layers of fiberglass mat, the layers of fiberglass mat having expanded volcanic ash between them and being bound together by epoxy, or (ii) two laminates, one of which is bonded to at least a portion of the surface of the core and the other one of which is bonded to at least a portion of the different surface of the core; and wherein each laminate comprises at least one layer of fiberglass mat having expanded volcanic ash within the pores thereof, wherein if (ii) is present, then at least one of the two laminates in (ii) is optionally a laminate as in (i).

In an embodiment of the invention, the composite comprises a thermoset resin that is epoxy, phenol formaldehyde or blends thereof. The composite also comprises low density filler that is a lightweight inorganic material such as pumice, pumiscite, perlite, expanded volcanic ash, or combinations thereof. Preferably, it is expanded volcanic ash or a combination therewith.

Polymeric microbeads are optionally present in the composite, and polystyrene microbeads are preferred.

A reinforcing filler that is a fiber-type material such as glass fiber, carbon fiber, cellulosic fiber and mineral fiber is optionally present in the composite.

An impact modifier is optionally present in the composite, and polyolefin is preferred.

A protein is optionally present in the composite, and the protein is preferably, but not limited to, a soy protein.

In another embodiment, the thermoset polymer is a polyurethane foam, and a skin is optionally present and comprises polyurea.

The present invention also contemplates methods for making the composite. The composite can be manufactured by conventional means such as in a conventional stationary mold. Thus, the components for the composite can be provided directly in the mold. Advantageously, however, the composite is prepared using the dynamic (traveling mold) method and system described herein.

The composite of the present invention can be made using any process amenable to this invention. In a process of preparing the composite of the invention, low pressure batch and continuous mixing are utilized, similar to those used in the agricultural and food industries for mixing dough and foodstuff formulations. In an embodiment, the composite components are subsequently formed into linear profile utilizing a lined (e.g., PTFE or silicone) forming station that is optionally equipped with infrared (i.e., IR), radio frequency (i.e., RF) or microwave heating stations.

In another embodiment, a composite can be produced by transferring the assembled but uncured composite into a mold. This can be advantageous for manufacturing a composite having complex geometry. The composite is subsequently allowed to cure and removed from the mold to produce the final product. The curing of the composite in the mold can also be accelerated by using an external heat source such as microwave, RF or IR energy. The mold can be passed through the curing station on a continuous belt. Preferably, the mold is dynamically formed as it passes along the belt and through the curing station.

Mixing and processing operations may be performed at a ambient temperature, although optimum operating temperatures are selected depending upon the specific curing rates of the thermoset resin utilized. However, the thermoset resin can be preheated in the process prior to mixing with low density filler, particularly naturally occurring low density filler. This effectively reduces the viscosity of the thermoset resin and can improve mixing and transfer operations. Controlling temperature of the resin can also control the curing kinetics such that the composite materials are mixed and formed in the most optimum fashion. In the absence of preheating the thermoset resin, the composite may be cured inline using thermal or microwave radiation. In an embodiment, the composite is cured using microwave radiation.

A method of making a composite in accordance with the present invention is provided, comprising:

(a) providing a mold having an interior surface;

(b) providing a first layer of fibrous material adjacent at least a portion of the interior surface of the mold, the layer having a first major face and a second major face, the first major face being towards that portion of the interior surface of the mold and the second major face being away from that portion of the interior surface of the mold;

(c) providing a first thermoset binder layer adjacent the first layer of fibrous material, the thermoset binder layer comprising thermoset binder and optionally a low density filler;

(d) providing a thermoset polymer adjacent the first thermoset binder layer;

(e) causing at least some of the thermoset binder of the first thermoset binder layer to flow into the first layer of fibrous material;

(f) curing the thermoset polymer to form a core; and

(g) curing the thermoset binder to form a laminate, the laminate comprising the layer of fibrous material and the thermoset binder; and

wherein the laminate is bonded to at least a portion of the core.

Note that the immediately preceding wording (including the use of the defined term “adjacent”) includes both of the following possibilities: (i) the first thermoset binder layer is provided between the first layer of fibrous material and the interior surface of the mold and (ii) the first layer of fibrous material is provided between the first thermoset binder layer and the interior surface of the mold. The immediately preceding wording also includes both of the following possibilities: (i) the thermoset polymer is provided proximate (immediately next to or contiguous with) the first layer of fibrous material and (ii) the thermoset polymer is provided proximate (immediately next to or contiguous with) the first thermoset binder layer.

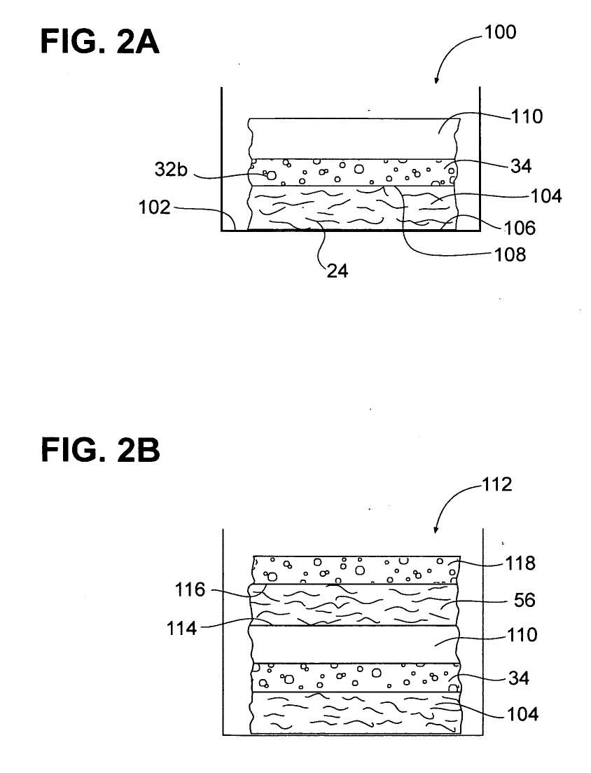

FIG. 2 depicts various aspects of providing component composite materials to a mold for curing. Two embodiments are shown in FIG. 2A and FIG. 2B. FIG. 2A depicts composite components in an open mold 100 for molding a composite (before the top of the mold has been put in place). As depicted, the components have been placed in the mold in an order suitable for molding the components into a composite. In accordance with the method, a mold is provided having an interior surface 102. A first fibrous material layer 104 is provided in the mold adjacent at least a portion of interior surface 102 of the mold. As shown, fibrous material layer 104 typically will not span the entire length of interior surface 102 of the mold, in order to allow for expansion to all sides of the mold upon curing. Fibrous material layer 104 has a first major face 106 and a second major face 108, the first major face 106 being towards that portion of interior surface 102 of the mold and the second major face 108 being away from that portion of interior surface 102 of the mold. First thermoset binder layer 34 which has thermoset binder and low density filler 32b is provided adjacent second major face 108 of first fibrous material layer 104. A thermoset binder layer without low density filler could alternatively be used, although including low density filler 32b as shown is preferred.

Layers 104 and 34 are here referred to, respectively, as “first” fibrous material layer and “first” thermoset binder layer. Although these are the only fibrous material layer and thermoset binder layer included in the composite components in open mold 100, this reference allows for easy designation in embodiments where an additional one or more of such layers are included.

Thermoset polymer 110 is provided adjacent first thermoset binder layer 34 and oppositely disposed across first thermoset binder layer 34 from the first fibrous material layer 104 comprising fibers 24. As depicted, thermoset polymer 110 is a layer of thermoset polymer. In a preferable embodiment, thermoset polymer 110 has low density binder mixed therewith (not shown).

Once the composite components in an open mold 100 are in place as shown in FIG. 2A, the mold is closed. At least some of the thermoset binder and low density filler 32b of first thermoset binder layer 34 are caused to flow into the first layer of fibrous material. This may be caused by conventional means such as externally applied heat and pressure. It is preferably caused, however, by heat and pressure generated from and during curing. As at least some of the thermoset binder and low density filler 32b of thermoset binder layer 34 enter first fibrous material layer 104, reference is made to FIG. 1A and FIG. 1C which show composites 10 and 28, respectively. In FIG. 1A, composite 10 has a first fibrous material layer that has thermoset binder 16′ in the interstices or pores between fibers. In FIG. 1C, composite 28 has a first fibrous material layer 30 containing thermoset binder 16′ and low density filler 32a.

Thermoset polymer 110 of FIG. 2A is cured to form core 20 and the thermoset binder is cured to form a laminate. As thermoset binder is caused to enter fibrous material layer 104, the laminate comprises the layer of fibrous material and the thermoset binder layer. In FIG. 1A and FIG. 1C, the respective laminates are shown as laminate 18 and laminate 36. The laminate is bonded to at least a portion of core 20 by the curing (or setting or hardening or cross-linking) of the one or more chemicals of the thermoset binder and thermoset polymer layers.

Preferably, at least a portion of each of the curing steps, which are designated (f) and (g) several paragraphs above, i.e., curing the thermoset polymer to form a core and curing the thermoset binder to form a laminate, occur simultaneously. Also preferably, the curing of the thermoset polymer helps cause at least some of the thermoset binder of the first thermoset binder layer, optionally comprising low density filler particles, (i) to flow into the first layer of fibrous material and (ii) to cure.

Advantageously, curing of the thermoset polymer 110 produces heat sufficient to cure the thermoset binder. In such preferred embodiment, the thermoset polymer 110 is most preferably a foaming polyurethane. Such a polyurethane will expand 10-30 times its pre-reaction volume as it reacts. Preferably in connection with the methods and systems of the present invention, if, for example, a three-pound free rise foam polyurethane is used, six pounds per cubic foot could be reacted rather than three to produce greater pressure in the mold. As the foaming polyurethane expands in a closed mold, it generates pressure of about 3-5 pounds per square inch. The exothermic heat generated by the reaction can raise temperatures in the center of the mold to over 350° F. As both heat and pressure are generated, the polyurethane reaction can cure both the core and the laminate. The laminate material, including the binder, fibrous material, and any low density filler and additive, is forced to the edge of the mold by the generated pressure to form and set in the desired shape of the mold as the thermoset binder cures from the generated heat. In this embodiment, heat and pressure need not be externally applied. The method is energy efficient in that what can be characterized as waste heat from the polyurethane curing reaction also forms and cures the laminate and molds the composite.

In a preferred embodiment, the presence of low density filler within any of the components of the composite helps keep the parts straight or in other desired configuration.

The thermoset binder and the thermoset polymer of the method can be any thermoset resin. For example, each can be independently selected from the group consisting of epoxies, polyurethanes, phenol-resorcinol polymers, urea-formaldehyde polymers, polyureas, phenol-formaldehyde polymers, melamine-formaldehyde polymers, soy-based polymers, polyesters, polyimides, acrylics, cyanoacrylates, polyanhydrides, polydicyclopentadienes, polycarbonates, blends of any of the foregoing, and blends of any of the foregoing with at least one linseed oil-based polymer.

The thermoset polymer of the method is preferably polyurethane or a blend of thermoset polymers comprising polyurethane. The thermoset binder of the method is preferably epoxy or a blend of thermoset binders comprising epoxy. More preferably, the method uses polyurethane as the thermoset polymer and epoxy as the thermoset binder.

The method can further comprise before the curing steps designated steps (f) and (g) providing at least one additional fibrous material layer and at least one additional thermoset binder layer in alternating relationship between (x) the first thermoset binder layer or fibrous material layer and (y) the thermoset polymer such that the thermoset polymer is provided proximate an additional thermoset binder layer or an additional fibrous material layer. Accordingly, the method comprises before steps (f) and (g), providing and positioning at least one additional fibrous material layer and at least one additional thermoset binder layer such that the order is first fibrous material layer, first thermoset binder layer, additional fibrous material layer, and additional thermoset binder layer.

In another embodiment, the method further comprises providing a low density filler to the thermoplastic polymer before step (e) and wherein the curing of step (f) forms a core comprising thermoset polymer and low density filler. In such an embodiment, thermoplastic polymer 110 in FIG. 2A would have low density filler therein (not shown).

Further in accordance with the method, the fibrous material is, for example, selected from the group consisting of glass fibers, carbon fibers, cellulosic materials, and aromatic polyamide fibers and wherein the fibrous material comprises a fiber having a tear strength of from about 1 to 25 pounds.

In accordance with the method of the present invention, low density laminate filler and the low density core filler are as described above. For example, each can be independently selected from the group consisting of expanded volcanic ash, pumice, perlite, pumiscite, mineral fillers, glass microspheres, soybean hulls, rice hulls, polymeric microspheres, cenospheres and vermiculite. The low density filler comprises particles measuring from about 10 to about 500 microns in at least one dimension.

In an embodiment, the method further comprises providing at least a portion of one or more outer surfaces of the composite with a skin adhered thereto. The skin is a coating which can be protective, decorative, etc. Non-limiting examples of substances which can comprise the skin are paint or a thermoset resin selected from the group consisting of polyureas, acrylics, non-rigid, non-foaming polyurethanes, and epoxies, and wherein the thermoset resin optionally comprises a low density filler or a reinforcing filler. Low density filler and reinforcing filler may overlap somewhat.

The method further comprises a method in which a composite is manufactured with an additional laminate. For reference, the composite produced would be, for example, as shown in FIG. 1F and in FIG. 1G, where FIG. 1G also includes a skin, which would be subsequently provided. The method comprises in addition to the steps described above:

(i) providing a layer of fibrous material for a second laminate, the second laminate fibrous material layer having a first major face and a second major face,

(ii) providing thermoset binder adjacent one of the major faces of the second laminate fibrous material layer, and

(iii) providing adjacent the thermoset polymer, and oppositely disposed across the thermoset polymer from the first thermoset binder layer, the second laminate fibrous material layer;

wherein step (e) further comprises causing at least some of the thermoset binder that is adjacent the major face of the second laminate fibrous layer to flow into and through the second laminate fibrous material layer and form a first layer of thermoset binder for a second laminate between the thermoset polymer and the second laminate fibrous material layer;

wherein step (g) further comprises curing the thermoset binder for forming the second laminate, the second laminate comprising the thermoset binder and the second laminate fibrous material layer; and

wherein the second laminate is bonded to at least a portion of the core.

In providing the second laminate, there are various ways in which the second laminate layer or layers of fibrous material and layer or layers of thermoset resin can be provided. In viewing FIG. 2A, it is possible to apply thermoset binder for the second laminate onto the top of thermoset polymer 110, and then provide the fibrous material layer for the second laminate onto the added thermoset binder (not shown). It is also possible to reverse that order and apply the fibrous material layer for the second laminate to the thermoset polymer and then apply the thermoset binder for the second laminate on top of the fibrous material layer. It is also possible to have thermoset binder for the second laminate applied to a fibrous material layer for the second laminate, and lay down the contiguous layers as a unit so that the thermoset binder of the unit directly or proximately contacts thermoset polymer 110 or to have the reverse, namely, the fibrous material layer of the unit directly or proximately contacts thermoset polymer 110. The immediately preceding language for the method in which a composite is manufactured with a second laminate includes all of the possibilities described in this paragraph.

FIG. 2B depicts composite components including two laminate components in an open mold 112 for molding a composite having two laminates oppositely disposed across the core. As shown, the configuration may appear counter-intuitive. Second laminate fibrous material layer 56 has first major face 114 and second major face 116. Major face 114 is both adjacent and proximate to thermoset polymer 110. Thermoset binder (which includes low density filler) 118 is shown both adjacent and proximate to second major face 116 of second fibrous material layer 56. This manner of providing the second laminate components allows for easy handling and positioning a fibrous material with thermoset binder thereon in the mold. During curing, thermoset binder (including low density filler) 118 will be forced into and through fibrous material layer 56, giving the order of composite components previously described as for FIG. 1F and FIG. 1G. In other words, a layer of thermoset binder with low density filler will be present in the molded composite between thermoset polymer 110 (which forms core 20) and fibrous material layer 56. Of course, the additional thermoset binder layer may be placed directly proximate thermoset polymer 110 and fibrous material layer 56 at the top, but that is not as convenient, e.g., for material handling reasons.

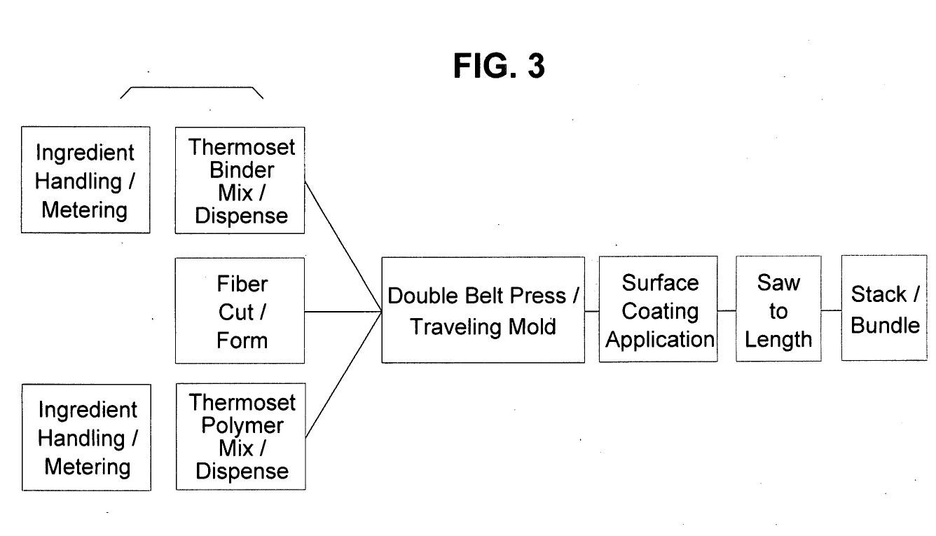

FIG. 3 is a simplified block diagram of a composite manufacturing line 200. The present invention can employ commercially available equipment. As shown, ingredient handling and mixing of thermoset resin is typically done separately for the thermoset resin composition for use as thermoset binder and for use as thermoset polymer. As follows, mixing and dispensing of the respective compositions are handled separately. If the same thermoset resin composition were to be used as both thermoset binder and thermoset polymer, it is possible that composition could be prepared in the same equipment for both. Ingredient handling includes providing intended ingredients, which are the thermoset resin or blend thereof and any low density filler and/or other additives.

The thermoset polymer and thermoset binder ingredients, respectively, as shown in FIG. 3 are metered and then mixed. In a preferred embodiment in which low density filler is included and/or other additives are included in a thermoset resin mixture, a calibrated rotating auger screw is used to move and feed the low density filler to the mixer. The thermoset resin and low density filler and any additives are simultaneously pumped/fed into a mixer that has been designed to provide good low intensity, low pressure mixing. The mixing portion of the mixing apparatus includes several screw flights of various density and pitch to effectively mix the thermoset formulation, whether intended as a thermoset binder or thermoset polymer mixture. In this processing, no external heat is applied to the system. As a result, the mixing occurs at room temperature or at the temperature of the composite mixture. At the end of the mixing screw, a short section of contained, high density flights are used to build slight pressure (˜100 psi) for mixing. Mixing in this manner is particularly useful where low density filler or other additive is included. A lubricant may be included to help reduce the effects of the low pressure on the thermoset resin mixture that is generated for mixing purposes.

This apparatus could also enable the thermoset resin mixture to adequately fill a single mold, or in the case of continuous process, to fill a moving belt mold.

Mixing and dispensing equipment can be obtained from Graco of Canton, Ohio. A Graco Delta Rim unit can be used to mix and dispense thermoset binder.

Another Graco Delta Rim unit can be used to mix and dispense thermoset polymer.

As also shown in FIG. 3, the width of the fibrous material may be cut as desired. The fibrous material can also be formed or shaped prior to cure. As generally shown and as will be described in further detail subsequent, the dispensed thermoset binder and the dispensed thermoset polymer along with fibrous material are moved into a double belt press having a traveling or dynamic mold. Curing occurs in the traveling mold.

The double belt press can be any available double belt press machine. As is known in the art, a double belt press has an upper belt and a lower belt, each belt being in the form of a closed or continuous loop. Each belt travels around two spaced-apart large end rollers and each belt has a portion facing the corresponding portion of the other belt along the longitudinal distance (major axis or direction of travel of the work-piece) of the machine. Thus, a belt travels around one roller, then toward the second roller over the distance, around the second roller and then moves back in the direction of the first roller and around it again, etc. The upper belt and its pair of rollers is disposed adjacent to the lower belt and its pair of rollers. A conveyor on which components for preparing a composite are placed travels into the area between the two adjacent belts. As the components are moved along the longitudinal distance, the thermoset resin or other moldable substance is cured and the composite or other item is molded. Double belt press machinery typically has apparatus placed along the longitudinal distance to assist in curing or other processing. A microwave or IR oven or RF energy source can be included for curing. Heating and cooling apparatus may be included and may be convection-type systems. Conventionally, the belts are non-stick (e.g., Teflon coated) and each presses against the material traveling through the belt press towards the other belt.

Double belt press apparatus and molds can be obtained from Sandvik of Chicago, Ill. Other commercially available equipment could alternatively be used.

As further indicated in FIG. 3, once the cured composite exits the mold, i.e., the double belt press, it can enter a coating station for surface coating application. Following surface treatment, the composite may be moved to be cut (e.g., sawed) to length.

A puller or conveyor is utilized to transport the component composite materials before, during and after curing, i.e., “the profile,” to and through the curing and up to the cutting station. The pulling apparatus pulls or moves the conveyor of the double belt press, which may also operatively connect to the spindles to have fibrous material travel along the guides and toward the double belt press. It may be located downstream of the coating station such that the composite exits the double belt press and may readily continue on for surface coating application. Alternatively, it may be integral with the double belt press. In such instance, the composite exiting the double belt press would be moved by other means. The pulling apparatus is any apparatus that operatively moves a belt or conveyor.

The composite is eventually transferred to an area for stacking and bundling for shipping. Automated stacking and handling equipment can be used.

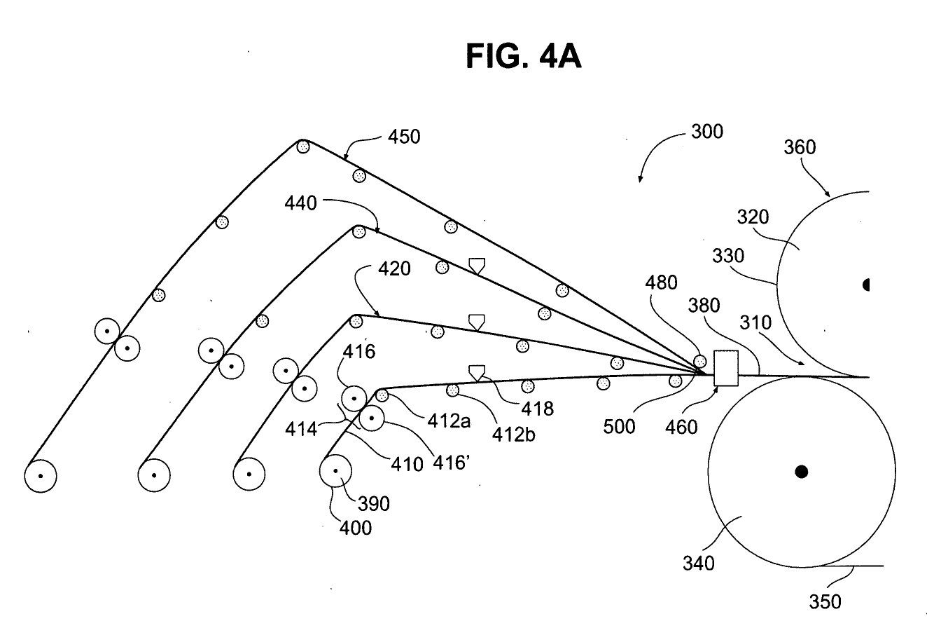

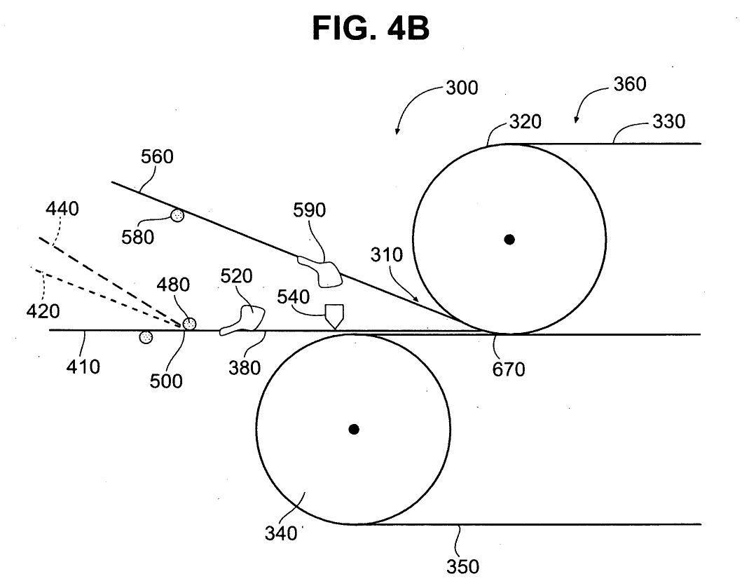

A system is provided for manufacturing a composite. Commercially available equipment may be arranged in the manner of the system of the present invention. FIG. 4 depicts a portion of the system of the present invention which involves providing and arranging composite component materials in-line to prior to entry into the double belt press mold. Reference is first made to FIG. 4A. FIG. 4A provides a broad view schematic of a system 300 in which composite component materials may be provided and arranged in-line for entry into and curing in a double belt press mold. The entry point 310 to a double belt press mold is shown. Upper first roller 320 moves upper belt 330, which travels around upper first roller 320. Lower first roller 340 moves lower belt 350, which travels around lower first roller 340. Lower belt 350 is shown in partial view extending longitudinally from lower first roller toward a lower second roller to the right (not shown). Upper belt 330 also extends toward upper second roller to the right (not shown). The rollers and belts comprise double belt press 360. Conveying surface 380 is the surface on which component composite materials are moved or transported into entry point 310.

Advantageously, the system comprises a first fibrous material processing line for preparing a first fibrous material with thermoset binder thereon. The first fibrous material processing line has first spindle 390 to hold first fibrous material 400 to provide a first fibrous material layer. First spindle 390 can be any spindle, rod, pole, shaft, cylinder, hinge, or any other item that provides a point from which the fibrous material can be discharged or pulled when it is operatively connected to double belt press 360. For example, fibrous material can be provided in a rolled configuration and placed around first spindle 390. First spindle 390 would allow the fibrous material to be rolled off or pulled therefrom.

First frame 410 defines a path upon which a first fibrous material layer travels toward double belt press 360. As shown, first frame 410 is delineated by first guide rods of which first guide rods 412a and 412b are identified. First guide rods 412a and 412b, etc., can each be any pin, rod, bar, pole, etc., and all are placed in a configuration so as to guide the fibrous material. First frame 410 could also be a belt or conveyor of any type.

First scoring apparatus 414 is shown disposed in the path of the first fibrous material layer. As shown, first scoring apparatus 414 is comprised of two scoring wheels, scoring wheel 416 and scoring wheel 416′, each of which is disposed on an opposite side of the path of fibrous material. Scoring wheels 416 and 416′ can thus score the fibrous material on a different side as it passes by first scoring apparatus 414. First scoring apparatus 414 prepares the fibrous material to subsequently be formed, shaped or folded prior to entry into the mold. It can do this by scoring, indenting or in any manner weakening the fibrous material along the one or more grooves, indentations, fold lines, etc., that it makes. Scoring wheels 416 and 416′ can do this by continuous contact. It is possible to use apparatus that could indent or puncture at intervals or any other apparatus that would achieve the groove(s), indentation(s), fold line(s), cut line(s), etc. desired.

First scoring apparatus 414 is used where, for example, a fibrous material is too wide (e.g., 7″ wide) and it is desired to have a smaller (e.g., 5″ wide) piece enter the mold (as the width of a side) before curing (in that case, about an inch on each side or about two inches on one side could be cut off). It is also useful where it is desired that a side next to the applied laminate components be formed with the applied laminate as described in connection with FIG. 1G. Scoring can therefore be done 1″ from the side of the 7″ mat on each side of the traveling fibrous material.

Scoring can be of just the fibrous material or of the fibrous material with thermoset binder thereon. If the latter were desired, then first scoring apparatus 414 would be disposed between the first dispenser 418 (for the resin) and double belt press 360 rather than the location shown between spindle 390 and the dispenser.

First dispenser 418 is disposed along the path of first frame 410 and dispenses a thermoset binder, optionally comprising a low density filler, onto the fibrous material as it travels along first frame 410. Once dispensed, a first thermoset binder layer is adjacent the first fibrous material layer. Any type of dispenser may be used. The dispenser is connected to a source of thermoset binder mixture.

The first fibrous material processing line continues as additional first guide rods guide the fibrous material with thermoset material thereon toward the double belt press. It may be that only one fibrous material layer is being used in the composite.

It may be desired, however, to provide more than one fibrous material layer to a laminate. As shown, a second fibrous material with thermoset binder thereon can be prepared using second fibrous material processing line 420. The same elements are provided as for the first fibrous material processing line described above. A third fibrous material with thermoset binder thereon can also be prepared using third fibrous material processing line 440. Further processing equipment could be provided, as shown. A fourth line 450 could be adapted for use by addition of a dispenser. The equipment is easy to handle and place in a different configuration as desired.

The location of first shaper 460 is shown. Shaper 460 shapes the first fibrous material at the fold line where it was scored or weakened by the scoring apparatus. Although thermoset binder is on the fibrous material when it reaches shaper 460 as shown, only the bottom side of fibrous material that is free from thermoset binder need contact the shaper. Shaper 460 is further addressed below.

In system 300, each of the first, second and third fibrous material layers with thermoset binder thereon travel toward double belt press 360. First fibrous material processing line is disposed below the second and the second is disposed below the third. The positioning of the frames for each processing line and convergence guide rod 480 allow for positioning of component laminate material in desired configuration such that the composite will desirably but not necessarily have fibrous material layer and thermoset binder layers in alternating relationship. As first fibrous material with thermoset binder thereon approaches convergence point 500, the second and third fibrous material layers with thermoset binder thereon also approach convergence point 500. The second fibrous material layer with thermoset binder thereon is caused to rest on the first thermoset binder as the third fibrous material with thermoset binder is caused to rest on second thermoset binder. This allows for easy handling and positioning of the uncured component laminate materials.

Double belt press 360 engages the first fibrous material layer and adjacent first thermoset binder layer such that the fibrous material can travel from each respective spindle, e.g., first spindle 390 for first fibrous material, and along each respective frame, e.g., first frame 410. It also permits the sandwich of component laminate parts (the three fibrous material layers with their respective thermoset binder layers) to move from convergence point 500 on conveyor 380 under convergence guide rod 480 toward the entry point 310.

FIG. 4B provides a closer view of the area of system 300 before entry of the composite into the double belt press mold in a system in which composite component material may be provided and arranged in-line. The dispensing of thermoset polymer is shown. Also, it depicts an embodiment is which component composite materials are provided for molding a composite having two laminates, one on either side of the core. Convergence point 500 and convergence guide rod 480 from FIG. 4A are shown to indicate where lower laminate component materials are sandwiched together. Also for orientation, the portions of double belt press 360 and entry point 310 from FIG. 4A are shown in FIG. 4B. Shaper 460 from FIG. 4A is here shown in a working configuration and is designated shaper 520.

Shaper 520 shapes the unit of three fibrous material layers and three thermoset binder layers by bending the unit along the grooves of all three fibrous material layers where they were scored by the three scoring apparatuses. The shaper can have any configuration and comprise any material that is inert and lets the fibrous material slide over it without sticking and, preferably, withstand the abrasiveness of some fibrous material passing along it as well as provide the desired shape. The shaper has a configuration that permits component composite parts to be shaped into the desired form prior to molding. It is disposed along the path of the fibrous material such that it catches the traveling fibrous material from the line of scoring to the outside edge thereof on one or both sides as the fibrous material passes along the shaper. After the shaper catches fibrous material, it causes the fibrous material to bend or curve. The shaper can be such that it is fairly flat in the area that the fibrous material first contacts it. The shaper gradually curves and the curvature continues to the desired degree. The shaper gradually changes the angle of bending of the fibrous material starting from the score line toward the edge to the degree desired.

In FIG. 4B, shaper 520 can catch and shape components for the laminate having a sandwich having three layers of mat. For a rectangular composite, for example, composite 60 in FIG. 1G, the shaper shapes the material such that it folds to close to a great enough angle so that it will position properly in the mold to produce the rectangular cross-section. Preferably, the shaper has a flat metal surface that gradually curves and is most preferably of a heavy grade stainless steel. The shaper can be any bendable surface. The shaper can alternatively be a rod or bar or a plurality of rods or bars having different curvatures set up as guides to provide the desired curved shape. Any other device or apparatus or shaped material can be used if the shaper provides the desired shaping for a fibrous material as the material travels past the shaper.

The shaper also assists in shaping the edges to consistent dimensions.

The laminate component materials sandwich travels from shaper 520 and passes thermoset polymer dispenser 540 (which was not shown in FIG. 4A), which is an apparatus for dispensing a thermoset polymer onto the top of the sandwich. The dispensing of thermoset polymer provides a thermoset polymer layer.

Thermoset polymer dispenser 540 is preferably as close as possible to the entry point 310 of double belt press in the preferred embodiment in which thermoset polymer is foaming polyurethane. Typically, it will be placed within a foot of actual entry to double belt press 360 to point in the direction indicated for entry point 310. Once the polyurethane is applied, it is preferred that no more than 15-20 seconds elapse until reaching the double belt press mold. Because the reaction time of the polyurethane is approximately 3 minutes, it is desirable to contain as much of the reaction as possible in the closed dynamic mold.

The speed at which the belt is moving and the length of the belt must be considered. To contain the three-minute reaction, for example, if the belt were run at 20 feet per minute, a minimum of a 60-foot double belt press mold length would be used. Reaction time could be varied somewhat chemically, for example, by use of a catalyst. One of skill in the art can vary these parameters as desired.

FIG. 4B also shows another embodiment for using the system of the invention such that a composite having two laminates (one on each major face of the core) is manufactured. Second laminate fibrous material processing line 560 and second laminate guide rod 580 generally designate the path along which second laminate component materials are processed and assembled. Equipment as shown in FIG. 4A can be used and is not shown in FIG. 4B for the second laminate. Second laminate fibrous material processing line 560 brings the second laminate to shaper 590. Shaper 590 is placed in the opposite configuration to shaper 520. Thus, shaper 590 shapes the sides folded downwardly. The shaped second laminate component materials are caused to rest on the components traveling along conveyor 380, which includes thermoset polymer on top of at least a portion of the first laminate component materials. In this manner, the resulting composite will resemble composite 60 of FIG. 1G.

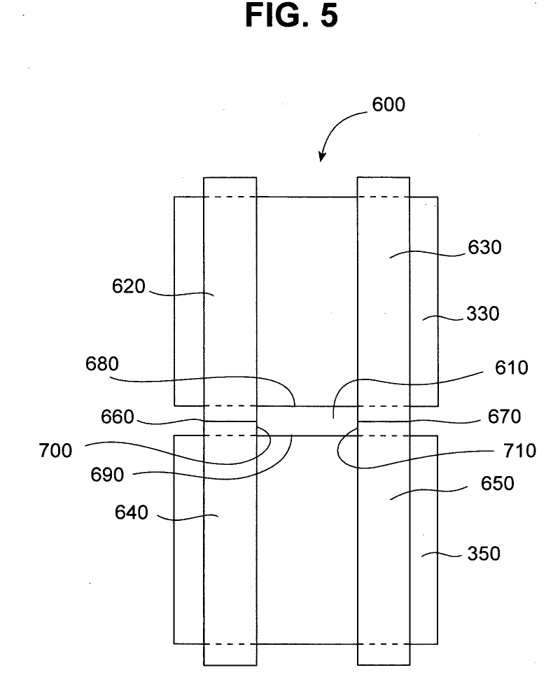

FIG. 5 shows an end view of double belt press 360 in the direction of the entry point 310 (looking from left to right in FIGS. 4A and 4B) showing area of dynamic mold 610. Upper belt 330 and lower belt 350 of double belt press 360 are shown. Upper belt 330 wraps around upper first roller 320 such that roller 320 is behind belt 330 in this view. Similarly, lower belt 350 wraps around lower first roller 340 such that roller 340 is behind belt 350.

Double belt press 360 is modified from a standard configuration to provide two bands disposed around each belt of the double belt press. Upper band 620 and upper band 630 are disposed around the upper belt 330 and spaced apart from each other. Lower band 640 and lower band 650 are disposed around lower belt 350 and spaced apart from each other. Upper band 620 and lower band 640 converge at what is designated band contact line 660. Upper band 630 and lower band 650 converge at what is designated band contact line 670. Contact of band 620 with band 640 and contact of band 630 with band 650 occurs substantially along the entire distance belts 330 and 350 are facing each other. Surface 680 is the surface of upper belt 330 between upper band 620 and upper band 630. Surface 690 is the surface of lower belt 350 between lower band 640 and lower band 650. Surfaces 680 and 690 face each other. Band side surface 700 is the inner surface of bands 620 and 640 facing bands 630 and 650. Band side surface 710 is the inner surface of bands 630 and 650 facing bands 620 and 640.

The space or volume bounded by the upper bands 620 and 630 and lower bands 640 and 650 (between band side surfaces 700 and 710) and upper belt 330 and lower belt 350 (between surfaces 680 and 690) defines a dynamic mold 610 in which the composite is held and can cure as it travels through double belt press 360. FIG. 5 shows the cross-sectional area of the dynamic mold volume of mold 610. That area exists along the entire length of the machine where the two belts face each other and the two sets of bands are in contact (the “band contact length”). The bands fit snugly around the belts and the bands press tightly against each other along the band contact length, thereby providing a leak-free, pressurizable traveling mold.

After the curing reactions and expansion have occurred, the composite cools sufficiently in the traveling mold. Cooling apparatus integral in the downstream portion of the double belt press can be used to assist in cooling. Thus, the cured composite exiting the double belt press advantageously does not require cooling prior to any further treatment. Returning to FIG. 3, the cured composite exits the double belt press on the conveyor and then advantageously enters the coating station for surface coating application. The cured composite can be surface treated using spray-on treatments, rotating brushes or embosser rolls. The coating or skin can be applied to one surface or to multiple surfaces. A coating material dispenser, brush, or roll, etc., can be disposed above and below the cured composite, for example, for dispensing the material as the composite travels through the coating station. High pressure Graco sprayers can be used, for instance. Surface treatments can be utilized to give the product a “wood” look. For some desired end uses, a composite can be surface treated for moisture or impact resistance. Surface treatments such as these are commonly used by PWC manufacturers for the same purpose.

Further embodiments of the system of the invention encompass the use of a first fibrous material processing line as indicated.

With reference to FIG. 4A, in an embodiment such as where second fibrous material processing line 420 is used, the system further comprises a second spindle to hold fibrous material to provide a second fibrous material layer; a second frame which defines a path upon which the second fibrous material layer travels toward the double belt press; a second dispenser for dispensing a thermoset binder optionally comprising a low density filler onto the fibrous material to provide a second thermoset binder layer adjacent the second fibrous material layer; optionally a second scoring apparatus that is disposed in the path of the second fibrous material layer and that scores the second fibrous material layer as it travels by the second scoring apparatus. The double belt press can engage the second fibrous material layer and adjacent second thermoset binder layer such that the second fibrous material layer can travel from the second spindle toward the double belt press, and wherein the path defined by the second frame can guide the second fibrous material layer and adjacent second thermoset binder layer to rest on the first thermoset binder layer. The same set-up can be used for third, fourth, and any additional processing lines for providing additional fibrous material layers for the laminate.

With reference to FIG. 4B, in an embodiment such as where second laminate fibrous material processing line 560 is used, the system further comprises: a second laminate first spindle to hold fibrous material to provide a first fibrous material layer for a second laminate; a second laminate first frame that defines a path upon which the second laminate first fibrous material layer travels toward the double belt press; a second laminate first dispenser for dispensing a thermoset binder optionally comprising a low density filler onto the second laminate first fibrous material layer to provide a second laminate thermoset binder adjacent the second laminate first fibrous material layer; optionally a second laminate first scoring apparatus that is disposed in the path of the second laminate first fibrous material layer and that scores the second laminate first fibrous material layer as it travels by the scoring apparatus; and optionally a shaper that shapes the second laminate first fibrous material where it was scored by the scoring apparatus. The double belt press can engage the second laminate first fibrous material layer and adjacent second laminate thermoset binder such that the second laminate first fibrous material layer can travel from the second laminate first spindle toward the double belt press, and wherein the path defined by the second laminate first frame can guide the second laminate first fibrous material and adjacent second laminate thermoset binder to rest on the thermoset polymer layer with the second laminate first fibrous material layer or the second laminate thermoset binder proximate the thermoset polymer. The same or similar set-up can be used for second, third, fourth and any additional processing lines for providing additional fibrous material layers to the second laminate before the second laminate components are placed on the thermoset polymer prior to entry into the dynamic mold of the double belt press.

The method of the present invention may be used to mold any composite parts of different shapes together or to adhere a composite being cured with another article that may have already been molded. To mold with a pre-cured article, the pre-cured part would be already present in the mold. The system using a double belt press mold in accordance with the present invention can be used.

The present invention also provides an apparatus for molding an object that comprises a moldable substance. The object may be moldable in that it has uncured thermoset resin or it may have any other moldable substance including clay or wax, for example. The apparatus used for moldable substances of the present invention is similar to that previously described and is depicted in FIG. 5. The apparatus comprises a double belt press having an upper belt and a lower belt. As previously noted, double belt presses are commercially available.

The apparatus also comprises two bands that are disposed around each belt of the double belt press. Upper band 620 and upper band 630 are disposed around the upper belt 330 and spaced apart from each other. Lower band 640 and lower band 650 are disposed around lower belt 350 and spaced apart from each other, and, as before, the volume defined by the faces of the two belts and inner sides of the four bands along the distance where the belts face each other is the volume in which the moldable substance is confined and may be heated, caused to react, and cooled, thereby shaping and hardening it in that shape.

In the double belt press according to the invention, upper bands 620 and 630 and lower bands 640 and 650 preferably can be moved or adjusted along the width of upper belt 330 and lower belt 350, respectively. In this manner, the distance between band side surfaces 700 and 710 can be made wider by moving the belts toward the edge or edges of the belts. The space between could be made smaller by moving or adjusting bands such that band side surfaces 700 and 710 are closer. Typically all bands would be adjusted, although one pair of upper and lower bands that converge (upper band 620 and lower band 640, or upper band 630 and lower band 650) can be adjusted. The distance between band side surfaces 700 and 710 defines the width of the traveling mold. Accordingly, it will define the distance of the article in that direction. The sides 700 and 710 of the two sets of bands need not be planar for articles that have stepped or non-planar sides.

The bands can be adhered or otherwise fastened to the belts. In preferred embodiments, however, the bands, which are elastic, are not fastened but rather are wrapped around the belts. When the double belt press is in use and the bands converge while moving, a tight seal is created between the bands starting at convergence lines 660 and 670 and between the bands and the belts where they are in contact. That tight seal ends near the distal rollers (at the distal or discharge end of the machine), where the two belts diverge. These seals prevent any of the material placed into the mold from leaking out.

The bands are of non-stick material and can be made of any elastic material with sufficient strength such as rubber. In a preferred embodiment, they are made of silicone rubber.

The apparatus of the present invention advantageously provides equipment that allows for a method of the present invention in which external pressure need not be applied to the materials for curing. The belts and the bands create the mold cavity. In preferred embodiments using foamed polyurethane, the pressure is generated by the chemical reaction and consequent expansion of materials and their being forced against the sides of the mold cavity.

As the apparatus of the invention can cure any moldable object, the apparatus can supply enough energy to the moldable substance to cause it to cure in the dynamic mold as the belts are moving. Thus, IR heat or other means of heating can be present within the double belt press. Such equipment, when present, is desirably placed closer to the entry point. Cooling apparatus can also be included, typically closer to the exit of the double belt press mold.

The composite of the invention is suitable as or for manufacturing articles in the building products and distribution industries. For example, in the building products industry, articles incorporating the composite of the present invention may include: decking, sheeting, structural elements, roofing tiles, and siding. The improved mechanical properties of the present composite enable thin and/or hollow profiles, thereby reducing cost and weight for particular end use applications. End applications of the composite of the invention are also quite suitable for outdoor use. The composite weathers moisture and sunlight quite well. Composites with a high degree of closed cell construct expanded volcanic ash are particularly preferred for outdoor product applications. Those of skill in the art of designing construction articles are capable of selecting specific profiles for various desired end use applications. Various non-limiting examples of end use applications are further discussed.

A new siding and roofing element is provided. Siding or roofing of the present invention can be prepared with a composite as described with at least one layer of fibrous material. The siding and roofing is easy to handle and install and also cost effective. Additional fibrous material layers can be used, although high strength is not critical for this application.

A siding or roofing panel can comprise a composite of the invention wherein the composite has an outer surface and a skin is adhered to the outer surface. The skin can comprise a substance taken from the group consisting of polyureas, acrylics, non-rigid, non-foaming polyurethanes, epoxies, paints, reinforcing fillers, ultraviolet protectants, impact modifiers, antioxidants, low density fillers, wood colorants, impact modifiers, heat stabilizers, flame retardants, insecticides, and fungicides.

Siding or roofing can also be prepared with an additional advantageous feature. This feature provides a “lock” between panels of the same configuration. It allows for easier installation and helps protects against warpage and separation from the building side or roof.

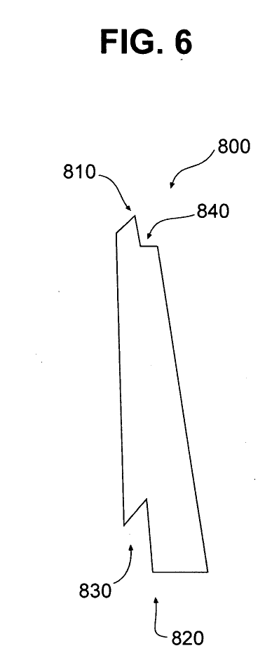

FIG. 6 shows siding panel 800 having indentations for placement with other panels having the same configuration on a building side. The siding or roofing panel of the invention can be a panel as siding panel 800 that has top edge 810 and bottom edge 820. Bottom edge 820 of panel 800 has indentation 830 such that panel 800 can rest on the top edge of a panel of the same configuration that is disposed below it, and top edge 810 of panel 800 has indentation 840 such that the bottom edge of another panel of the same configuration can rest on top of panel 800 and wherein indentations 830 and 840 are in tongue and groove configuration. The configuration allows the siding or roofing panels to be placed and “locked” together while installed on a building side or roof. The size and shape of the top and bottom indentations can be varied to provide different degrees of locking and different appearances to the individual panels and assemblies of panels. For example, for a panel of approximately nine to eleven inches in height, the thickness at the top (the distance between the two major faces) could be about three-eighths of an inch and the thickness at the bottom (the distance between the two major faces) could be about three-quarters of an inch.

End applications requiring greater strength typically have at least one composite wherein (i) the composite comprises at least one laminate and the at least one laminate comprises at least two layers of fibrous material; or (ii) the core comprises the surface and a different surface and the composite comprises at least two laminates, one of which is bonded to at least a portion of the surface of the core, and one of which is bonded to at least a portion of the different surface of the core and wherein each laminate comprises at least one layer of fibrous material. For reference, a composite meeting either or both of these options is referred to as Composite 1.

Deck board of variable strength is an embodiment of the invention. A composite having good strength characteristics, e.g., Composite 1, can be used. Preferably, stronger deck boards are prepared using at least four or five fibrous material mat layers. A five-glass layer construct would have a MOE of about 1.2-1.3×10⁶ PSI or the equivalent of a similar dimension of softwood.

Also preferably, deck board is prepared using a polyurethane core, epoxy thermoset resin, and expanded volcanic ash in the laminate(s). More preferable is use of expanded volcanic ash with a high degree of closed cell construct. Deck board of the invention has improved qualities in being essentially impervious to water absorption and insects.

A protective skin is used. This can be either polyurethane, polyurea, or aliphatic compounds. The skin can comprise multiple applications of protective substances to provide UV protection and durability. Surface conditions are of importance to end users. Even though consumers want a non-wood, low maintenance part, they also want their deck to look like wood. Strength, weight, and cost ratios of this deck board are all favorable.

A deck board of the invention can comprise a composite identified as Composite 1 wherein the composite has an outer surface and a skin is adhered to the outer surface. The skin preferably comprises a substance selected from the group consisting of polyureas, acrylics, non-rigid, non-foaming polyurethanes, epoxies, paints, reinforcing fillers, ultraviolet protectants, impact modifiers, antioxidants, low density fillers, wood colorants, impact modifiers, heat stabilizers, flame retardants, insecticides, and fungicides.

A key product for the home improvement markets is composite structural lumber which has high strength requirements. Even the latest developments in the art do not provide composites with the strength to replace wood in structural support beams. Structural lumber is used in many applications, for example, as the structural support posts for decking to which the surface boards are applied. The support system is the most expensive part of decking material. The parts of this invention can be manufactured to the dimensions of lumber such as 2×8's, 2×10's, 2×12's, etc. They have the capability to span longer distances. Advantageously, the building component of the present invention composites meet the requirements of a replacement for wood. The building component may have many other uses as well, for example, as flooring.

The present invention provides a building component comprising a composite designated Composite 1 and additional fibrous material. The composite for a building component comprises (i) at least one laminate which comprises at least three layers of fibrous material; or (ii) the core comprises the surface and a different surface and the composite comprises at least two laminates, one of which is bonded to at least a portion of the surface of the core, and one of which is bonded to at least a portion of the different surface of the core and wherein one laminate comprises at least one layer of fibrous material and the other laminate comprises at least two layers of fibrous material.

Preferably, there are at least five layers of fibrous material layer in the composite comprising a building component, whether within one laminate or two. Additional layers may be used as they further increase the MOE and stiffness of the part. For example, ten or more fibrous material layers can be used.

Deck board fastening has typically been problematic. Nails have obvious problems because of wood warping and can cause injury to feet, etc. Even hidden fasteners are not ideal due to cost and application time. Deck board parts can be secured together according to the method of the present invention. The method may be used to adhere any composite parts together or to adhere a composite being molded in accordance with the invention with another article that may have already been cured.

The composite of the present invention is particularly useful for the production of pallet sheets and pallets for use in the distribution industry. The pallet sheets and pallets made using the composite of this invention have the additional advantage that they have very high moisture and microbial resistance, making them ideal for applications that require sterilization. Pallet sheets and pallets of the invention offer weight, cost and durability advantages.

Typically, a pallet sheet is a thin, line layer sheet used mainly for specialized in-plant or freight operations. It is also used to handle light weight freight. Pallet sheets are often used in bakeries, snack plants, etc.

A pallet sheet for carrying one or more objects is provided which comprises a composite of the present invention which has at least one fibrous material layer. The composite has at least one surface on which the one or more objects rest when being carried on the pallet sheet and the at least one surface defines at least one notch to facilitate moving the pallet. The pallet sheet also comprises a skin bonded to at least a portion of the surface of the composite. The notch or notches can be, for example, at least one and preferably two cut out portions for hand holds to allow manual lifting accessibility. The notch or notches could alternatively be such as to facilitate mechanical and/or robotic attachment for lifting.

A pallet for carrying one or more objects is provided which comprises a composite of the present invention having at least one fibrous material layer and that has at least one surface on which the one or more objects rest when being carried on the pallet and at least one side. The composite of the invention preferably provides the surface for the objects. The at least one side defines at least one notch to facilitate moving the pallet. The side having a notch is for forklift or other mechanical or robotic accessibility for lifting. It could alternatively be for manual lifting. The pallet also comprises a skin bonded to at least a portion of the surface of the composite and posts connected to the composite. The skin preferably provides impact resistance and preferably includes a low density filler, e.g., expanded volcanic ash. At least two posts, typically four or more posts, can be connected to a surface for supporting the objects. Pallets of the invention can have posts molded with a surface for carrying objects or separate posts, whether all are being cured together or some parts were previously cured. The posts can be otherwise fastened or attached to the surface by mechanical means. The composite having the surface optionally has cut out portions for manual or other lifting accessibility. Preferably, both the composite defining the surface and the posts are composites of the invention.

Pallets having greater strength are also provided. In this embodiment, the pallet as above comprises at least two composites and at least two posts, wherein at least one of the composites is a composite of Composite 1. Each of the posts is connected to one of the composites such that the posts define a space between the composites when they are placed with the posts between them. In this configuration, there is an upper composite with a surface and a lower composite with a surface, each composite being spaced apart from the other by the posts between. Composites having surfaces intended for lifting of heavy objects, for instance, have at least the number of fibrous material layers as in Composite 1, preferably more. A pallet can have a composite having 4 or more, e.g., 10 or more, fibrous material layers. The composite that provides a surface for holding heavy objects and/or for providing access to a forklift or pallet jack preferably has a hatch or cross construction as is known in the art to provide additional sturdy construction for durability in withstanding heavy loads and/or wear and tear from forklift or pallet jack lifting and transport. The pallet can have at least two posts. A nine-post pallet is advantageous in that it can provide at least four notches, at least one for each side. Thus, a forklift or pallet jack can access a notch from any of the four sides.

Aspects of the previously discussed pallet apply to the high strength pallet. For example, both the composites defining the surfaces and the posts can be, and preferably are, composites of the invention. Also, each of the composites having the surfaces typically has at least one of the posts connected thereto by a molding or mechanical means as discussed.

Another use of the composite of the invention is in a unit of furniture for use as a table or seating comprising a composite of Composite 1 which has at least one surface on which one or more objects or a person rests when on the furniture. It also has a skin bonded to at least a portion of the surface of the composite and legs, each of which is a composite of Composite 1 and each of which is connected to the composite having the surface. The legs can be molded with the composite having the surface in one of the ways discussed, or mechanically or otherwise attached or adhered. A skin having a surface coating with a wood stain or other paint desirable for customers may be provided.

Further possible uses for the composite of the invention are contemplated. The composite may be used in any moldable object, e.g., covers, toy pieces, tools, carriers (e.g., buckets, wheel barrows, etc.), preassembled parts for automobiles (e.g., steering wheel, dashboard panels, etc.).

In another aspect of the present invention, low density filler can be used in a manner to provide a rigid light-weight member for use in an application that does not require high strength. Preferably, inorganic low density filler is used, preferably expanded volcanic ash. Preferably, the thermoset polymer is a foamed polyurethane or a blend comprising foamed polyurethane.

The rigid light-weight member comprises a layer that is like the core of the high-strength composite discussed above. For the rigid light-weight member, however, a laminate component for imparting strength is not included. A rigid member in accordance with the invention comprises (a) a construct comprising from about 60% to about 90% by weight of a thermoset polymer and from about 10% to about 40% by weight of low density filler and having a surface; and (b) a skin which is adhered to at least a portion of the surface of the construct; and wherein the member has a density of from about 0.1 to about 40 pounds per cubic foot. Preferably, the low density filler is expanded volcanic ash.

In an embodiment, the density of the rigid member is from about 0.1 to about 35 pounds per cubic foot. In another embodiment, the density is from 0.1 to 30 pounds per cubic foot. In a further embodiment, the density is from about 0.5 to 35 pounds per cubic foot.

Typically, the rigid member would be substantially free from reinforcing fillers that are not also characterized as low density fillers of the present invention. Small amounts of additives are possible as long as the targeted density of the rigid member is met. Sucrose can be added to thermoset polymer prior to curing, for instance.

The rigid light-weight member can have a MOE of from about 40,000 to 60,000 PSI. The construct may be used as a decorative layer or otherwise where the part will not need to provide weight-bearing strength. It may be used as a fascia board, for example.

### EXAMPLE 1

### Core Formulations

The following are examples of core formulations. The values listed for a given substance are reported in weight percent of the weight of the core.

| Core | | | Poly- | | Phenol- | Soy |
|---|---|---|---|---|---|---|
| Formula | Ash | Epoxy | urethane | Polyurea | Formaldehyde | Resin |
| 1 | 40 | 60 | — | — | — | — |
| 2 | 40 | 30 | — | — | 30 | — |
| 3 | 40 | — | — | — | 60 | — |
| 4 | 40 | — | — | — | — | 60 |
| 5 | 40 | — | — | — | 30 | 30 |
| 6 | 40 | 30 | — | — | — | 30 |
| 7 | 20 | — | 40 | 40 | — | — |

In composites prepared with listed Core Formulations 1-7 in accordance with the present invention, the specific gravity has been determined as 0.40-0.50 grams per cubic centimeter and improved mechanical properties have been observed.

### EXAMPLE 2

### Composite Formula

In this Example, a composite was prepared having a core, a laminate with two layers of glass mat and a surface coating. Kamco 5 expanded volcanic ash from Kansas Minerals, Inc. of Mankato, Kans., was included in all component parts of the composite. The weight percentages of the following are reported as weight percent of the composite:

| | |
|---|---|
| Expanded Volcanic Ash (wt %) | 40 |
| Epoxy (wt %) | 15 |
| Polyurethane (wt %) | 15 |
| Polyurea (wt %) | 15 |
| Fiberglass (wt %) | 15 |

The 15% epoxy encompassed both the epoxy and the cure agent. Dow 383 or 324 was used. Polyurethane weight percentages include both polyol and isocyanate. VF 742 from Volatile Free, Inc. of Milwaukee, Wis. was used. The polyurea coating was obtained from Volatile Free, Inc.

The resulting composite is suitable for manufacturing deck board, for instance.

What is claimed is:

1. A composite comprising:
(a) a core comprising a thermoset polymer and having a surface; and
(b) a laminate bonded to at least a portion of the surface of the core, the laminate comprising:
(i) at least one layer of fibrous material having a surface, and
(ii) at least one layer of thermoset binder which is bonded to at least a portion of the surface of at least one layer of fibrous material, and wherein each thermoset binder layer optionally comprises a low density filler.

2. The composite of claim 1 wherein at least one of the at least one thermoset binder layers comprises the low density filler.

3. The composite of claim 2 wherein at least one of the at least one thermoset binder layers is bonded to at least a portion of the surface of the core.

4. The composite of claim 2 wherein at least one of the at least one layers of fibrous material is porous and has a thermoset binder within at least a portion of the pores thereof and wherein the thermoset binder within the pores of the fibrous material is the same as the thermoset binder in the at least one layer of thermoset binder.

5. The composite of claim 2 wherein:
(i) the composite comprises at least one laminate and the at least one laminate comprises at least two layers of fibrous material; or
(ii) the core comprises the surface and a different surface and the composite comprises at least two laminates, one of which is bonded to at least a portion of the surface of the core, and one of which is bonded to at least a portion of the different surface of the core and wherein each laminate comprises at least one layer of fibrous material.

6. The composite of claim 5 wherein immediately adjacent layers of fibrous material have between them the thermoset binder layer.

7. The composite of claim 2 wherein the fibrous material comprises a fiber having a tear strength of from about 1 to 25 pounds.

8. The composite of claim 2 wherein the fibrous material is selected from the group consisting of glass fibers, carbon fibers, cellulosic materials, and aromatic polyamide fibers.

9. The composite of claim 2 wherein the thermoset binder and the thermoset polymer are each independently selected from the group consisting of epoxies, polyurethanes, phenol-resorcinol polymers, urea-formaldehyde polymers, polyureas, phenol-formaldehyde polymers, melamine-formaldehyde polymers, soy-based polymers, polyesters, polyimides, acrylics, cyanoacrylates, polyanhydrides, polydicyclopentadienes, polycarbonates, blends of any of the foregoing, and blends of any of the foregoing with at least one linseed oil-based polymer.

10. The composite of claim 9 wherein the thermoset binder is epoxy or a blend of thermoset binders comprising epoxy.

11. The composite of claim 9 wherein the thermoset polymer is polyurethane or a blend of thermoset polymers comprising polyurethane.

12. The composite of claim 2 wherein the low density thermoset binder filler comprises particles measuring from about 10 to about 500 microns in at least one dimension.

13. The composite of claim 2 wherein the core further comprises a low density filler.

14. The composite of claim 13 wherein the low density thermoset binder filler and the low density core filler are each independently selected from the group consisting of expanded volcanic ash, pumice, perlite, pumiscite, mineral fillers, glass microspheres, soybean hulls, rice hulls, polymeric microspheres, cenospheres and vermiculite.

15. The composite of claim 2 wherein the composite has an outer surface and a skin is adhered to at least a portion of the outer surface of the composite.

16. The composite of claim 15 wherein the skin comprises paint or a thermoset resin selected from the group consisting of polyureas, acrylics, non-rigid, non-foaming polyurethanes, and epoxies, and wherein the thermoset resin optionally comprises a low density filler or a reinforcing filler.

17. The composite of claim 15 wherein the composite further comprises an additive selected from the group consisting of ultraviolet protectants, compatibilizers, antioxidants, glass fibers, carbon fibers, cellulosic fibers, mineral fibers, heat stabilizers, colorants, flame retardants, insecticides, fungicides, plasticizers, tackifiers, processing aids, foaming agents, impact modifiers and proteins.

18. The composite of claim 2 wherein the composite has a specific gravity of from about 0.20 grams per cubic centimeter to about 0.80 grams per cubic centimeter, a modulus of elasticity greater than about 500,000 pounds per square inch, a modulus of rupture of greater than about 2,000 pounds per square inch, and a coefficient of thermal expansion of from about 2.0×10⁻⁷ in/in/° F. to 2.0×10⁻⁵ in/in/° F.

19. The composite of claim 3 wherein bonding of the thermoset binder layer to the core results from the thermoset binder or the thermoset polymer of the core curing while in contact with the other.

20. The composite of claim 19 wherein the bonding results from the thermoset binder and the thermoset polymer each curing while in contact with the other.

21. A composite comprising:
(a) a core comprising polyurethane and expanded volcanic ash and having a surface and a different surface; and
(b) at least one of the following:
(i) a laminate bonded to at least a portion of the surface of the core, the laminate comprising at least two layers of fiberglass mat, the layers of fiberglass mat having expanded volcanic ash between them and being bound together by epoxy; or
(ii) two laminates, one of which is bonded to at least a portion of the surface of the core and one of which is bonded to at least a portion of the different surface of the core;
wherein each laminate comprises at least one layer of fiberglass mat having expanded volcanic ash within the pores thereof, and
wherein if (ii) is present, then at least one of the two laminates in (ii) is optionally a laminate as in (i).

22. A method of making a composite comprising:
(a) providing a mold having an interior surface;
(b) providing a first layer of fibrous material adjacent at least a portion of the interior surface of the mold, the layer having a first major face and a second major face, the first major face being towards that portion of the interior surface of the mold and the second major face being away from that portion of the interior surface of the mold;
(c) providing a first thermoset binder layer adjacent the first layer of fibrous material, the thermoset binder layer comprising thermoset binder and optionally a low density filler;
(d) providing a thermoset polymer adjacent the first thermoset binder layer;
(e) causing at least some of the thermoset binder of the first thermoset binder layer to flow into the first layer of fibrous material;
(f) curing the thermoset polymer to form a core; and
(g) curing the thermoset binder to form a laminate, the laminate comprising the layer of fibrous material and the thermoset binder; and
wherein the laminate is bonded to at least a portion of the core.

23. The method of claim 22 wherein the first thermoset binder layer comprises the low density filler.

24. The method of claim 23 further comprising before steps (f) and (g) providing and positioning at least one additional fibrous material layer and at least one additional thermoset binder layer such that the order is first fibrous material layer, first thermoset binder layer, additional fibrous material layer, and additional thermoset binder layer.

25. The method of claim 23 wherein at least a portion of each of steps (f) and (g) occur simultaneously.

26. The method of claim 23 wherein the curing of the thermoset polymer helps cause at least some of the thermoset binder of the first thermoset binder layer (i) to flow into the first layer of fibrous material and (ii) to cure.

27. The method of claim 23 wherein the composite has an outer surface and the method further comprises providing at least a portion of the outer surface with a skin adhered thereto.

28. The method of claim 23 wherein the fibrous material is selected from the group consisting of glass fibers, carbon fibers, cellulosic materials, and aromatic polyamide fibers and wherein the fibrous material comprises a fiber having a tear strength of from about 1 to 25 pounds.

29. The method of claim 23 wherein the thermoset binder and the thermoset polymer are each independently selected from the group consisting of epoxies, polyurethanes, phenol-resorcinol polymers, urea-formaldehyde polymers, polyureas, phenol-formaldehyde polymers, melamine-formaldehyde polymers, soy-based polymers, polyesters, polyimides, acrylics, cyanoacrylates, polyanhydrides, polydicyclopentadienes, polycarbonates, blends of any of the foregoing, and blends of any of the foregoing with at least one linseed oil-based polymer.

30. The method of claim 29 wherein the thermoset binder is epoxy or a blend of thermoset binders comprising epoxy.

31. The method of claim 29 wherein the thermoset polymer is polyurethane or a blend of thermoset polymers comprising polyurethane.

32. The method of claim 23 wherein the low density filler of the first thermoset binder comprises particles measuring from about 10 to about 500 microns in at least one dimension.

33. The method of claim 23 further comprising providing a low density filler to the thermoplastic polymer before step (e) and wherein the curing of step (f) forms a core comprising thermoset polymer and low density filler.

34. The method of claim 33 wherein the low density laminate filler and the low density core filler are each independently selected from the group consisting of expanded volcanic ash, pumice, perlite, pumiscite, mineral fillers, glass microspheres, soybean hulls, rice hulls, polymeric microspheres, cenospheres and vermiculite.

35. The method of claim 27 wherein the skin comprises paint or a thermoset resin selected from the group consisting of polyureas, acrylics, non-rigid, non-foaming polyurethanes, and epoxies, and wherein the thermoset resin optionally comprises a low density filler or a reinforcing filler.

36. The method of claim 23 further comprising
(i) providing a layer of fibrous material for a second laminate, the second laminate fibrous material layer having a first major face and a second major face,
(ii) providing thermoset binder adjacent one of the major faces of the second laminate fibrous material layer, and
(iii) providing adjacent the thermoset polymer, and oppositely disposed across the thermoset polymer from the first thermoset binder layer, the second laminate fibrous material layer;
wherein step (e) further comprises causing at least some of the thermoset binder that is adjacent the major face of the second laminate fibrous layer to flow into and through the second laminate fibrous material layer and form a first layer of thermoset binder for a second laminate between the thermoset polymer and the second laminate fibrous material layer;
wherein step (g) further comprises curing the thermoset binder for forming the second laminate, the second laminate comprising the thermoset binder and the second laminate fibrous material layer; and
wherein the second laminate is bonded to at least a portion of the core.

37. A pallet sheet for carrying one or more objects, the pallet sheet comprising:
(a) a composite according to claim 2 that has at least one surface on which the one or more objects rest when being carried on the pallet sheet and wherein the at least one surface defines at least one notch to facilitate moving the pallet; and
(b) a skin bonded to at least a portion of the surface of the composite.

38. A pallet for carrying one or more objects, the pallet comprising:
(a) a composite according to claim 2 that has at least one surface on which the one or more objects rest when being carried on the pallet and at least one side and wherein the at least one side defines at least one notch to facilitate moving the pallet;
(b) a skin bonded to at least a portion of the surface of the composite; and
(c) posts connected to the composite.

39. The pallet according to claim 38 wherein the pallet comprises at least two composites and at least two posts, wherein at least one of the composites is a composite of claim 5 and wherein each of the posts is connected to one of the composites such that the posts define a space between the composites when the composites are placed with the posts between them.

40. A rigid member comprising
(a) a construct comprising from about 60% to about 90% by weight of a thermoset polymer and from about 10% to about 40% by weight of low density filler and having a surface; and
(b) a skin which is adhered to at least a portion of the surface of the construct; and
wherein the member has a density of from about 0.1 to about 40 pounds per cubic foot.

41. A deck board comprising a composite of claim 5 wherein the composite has an outer surface and a skin is adhered to the outer surface and the skin comprises a substance taken from the group consisting of polyureas, acrylics, non-rigid, non-foaming polyurethanes, epoxies, paints, reinforcing fillers, ultraviolet protectants, impact modifiers, antioxidants, low density fillers, wood colorants, impact modifiers, heat stabilizers, flame retardants, insecticides, and fungicides.

42. A building component comprising a composite of claim 5 wherein
(i) the composite comprises at least one laminate and the at least one laminate comprises at least three layers of fibrous material; or
(ii) the core comprises the surface and a different surface and the composite comprises at least two laminates, one of which is bonded to at least a portion of the surface of the core, and the other one of which is bonded to at least a portion of the different surface of the core and wherein one laminate comprises at least one layer of fibrous material and the other laminate comprises at least two layers of fibrous material.

43. A siding or roofing panel comprising a composite of claim 2 wherein the composite has an outer surface and a skin is adhered to the outer surface and the skin comprises a substance taken from the group consisting of polyureas, acrylics, non-rigid, non-foaming polyurethanes, epoxies, paints, reinforcing fillers, ultraviolet protectants, impact modifiers, antioxidants, low density fillers, wood colorants, impact modifiers, heat stabilizers, flame retardants, insecticides, and fungicides.

44. The siding or roofing panel of claim 43 which is a panel that has a top edge and a bottom edge and wherein the bottom edge of the panel has an indentation such that the panel can rest on the top edge of a second panel of the same configuration that is disposed below it, and the top edge of the panel has an indentation such that bottom edge of a third panel of the same configuration can rest on top of the panel and wherein the indentations are in tongue and groove configuration.

45. A unit of furniture for use as a table or seating comprising
(a) a composite according to claim 5 that has at least one surface on which one or more objects or a person rests when on the furniture;
(b) a skin bonded to at least a portion of the surface of the composite; and
(c) legs, each of which is a composite of claim 5 and each of which is connected to the composite of (a) to support it when the one or more objects or person is on the furniture.

46. A system for manufacturing a composite comprising:
a first spindle to hold a fibrous material to provide a first fibrous material layer;
a first frame that defines a path upon which the first fibrous material layer travels toward a double belt press;
a first dispenser for dispensing a thermoset binder optionally comprising a low density filler onto the fibrous material to provide a first thermoset binder layer adjacent the first fibrous material layer;
optionally a first scoring apparatus that is disposed in the path of the first fibrous material layer and that scores the first fibrous material layer as it travels by the first scoring apparatus;
optionally a first shaper that shapes the first fibrous material where it was scored by the scoring apparatus;
a double belt press that can engage the first fibrous material layer and adjacent first thermoset binder layer such that the fibrous material can travel from the first spindle toward the double belt press, the double belt press having an upper belt and a lower belt that for at least some distance face each other;
an apparatus for dispensing a thermoset polymer onto the thermoset binder or the first fibrous material layer to provide a thermoset polymer layer, thereby forming an uncured composite;
bands disposed around each belt of the double belt press, wherein two bands are disposed around the upper belt and spaced apart and two bands are disposed around the lower belt and spaced apart such that for at least some of the distance where the belts are facing each other the bands around the upper belt and the bands around the lower belt are in contact and the space bounded by the upper bands, lower bands, upper belt, and lower belt defines a dynamic mold in which the uncured composite is held and can cure as it travels through the double belt press.

47. The system according to claim 46 further comprising:
a second spindle to hold fibrous material to provide a second fibrous material layer;
a second frame which defines a path upon which the second fibrous material layer travels toward the double belt press;
a second dispenser for dispensing a thermoset binder optionally comprising a low density filler onto the fibrous material to provide a second thermoset binder layer adjacent the second fibrous material layer;
optionally a second scoring apparatus that is disposed in the path of the second fibrous material layer and that scores the second fibrous material layer as it travels by the second scoring apparatus;
wherein the double belt press can engage the second fibrous material layer and adjacent second thermoset binder layer such that the second fibrous material layer can travel from the second spindle toward the double belt press, and wherein the path defined by the second frame can guide the second fibrous material layer and adjacent second thermoset binder layer to rest adjacent the first thermoset binder layer and the first fibrous material layer.

48. The system of claim 46 further comprising
a second laminate first spindle to hold fibrous material to provide a first fibrous material layer for a second laminate;
a second laminate first frame that defines a path upon which the second laminate first fibrous material layer travels toward the double belt press;
a second laminate first dispenser for dispensing a thermoset binder optionally comprising a low density filler onto the second laminate first fibrous material layer to provide a second laminate thermoset binder adjacent the second laminate first fibrous material layer;
optionally a second laminate first scoring apparatus that is disposed in the path of the second laminate first fibrous material layer and that scores the second laminate first fibrous material layer as it travels by the scoring apparatus;
optionally a shaper that shapes the second laminate first fibrous material where it was scored by the scoring apparatus;
wherein the double belt press can engage the second laminate first fibrous material layer and adjacent second laminate thermoset binder such that the second laminate first fibrous material layer can travel from the second laminate first spindle toward the double belt press, and wherein the path defined by the second laminate first frame can guide the second laminate first fibrous material and adjacent second laminate thermoset binder to rest on the thermoset polymer layer with the second laminate first fibrous material layer or the second laminate thermoset binder proximate the thermoset polymer.

49. The system of claim 46 further comprising
a dispenser disposed in the path of the cured composite after it exits the double belt press for dispensing a surface coating onto the cured composite.

50. A method of making a composite using the system of claim 46 wherein the thermoset polymer is a foaming polyurethane or a blend comprising a foaming polyurethane and wherein as the polyurethane foams in the mold, the reaction generates heat and pressure that cause thermoset binder to enter the adjacent fibrous material layer and curing of the thermoset binder.

51. The method of claim 49 wherein the thermoset binder is epoxy or a blend comprising epoxy.

52. An apparatus for molding an object that comprises a moldable substance, the apparatus comprising a double belt press having an upper belt and a lower belt and bands that are disposed around each belt of the double belt press, wherein two bands are disposed around the upper belt and spaced apart and two bands are disposed around the lower belt and spaced apart such that for at least some of the distance where the belts are facing each other, one of the bands around the upper belt and the one of the bands around the lower belt are in contact when the belts are moving and the other band around the upper belt and the other band around the lower belt are in contact when the belts are moving and the space defined by the area between the upper bands, lower bands, upper belt, and lower belt is a dynamic mold for molding the object as it travels through the double belt press.

53. The apparatus of claim 52 wherein the bands are non-stick.

54. The apparatus of claim 52 wherein the non-stick bands comprise silicone rubber.

55. The apparatus of claim 52 wherein the apparatus can supply enough energy to the moldable substance to cause it to cure in the dynamic mold as the belts are moving.
